(19) United States
(12) Patent Application Publication
(10) Pub. No.: US 2025/0212062 A1
(43) Pub. Date: Jun. 26, 2025

(54) COMMUNICATIONS FOR FAST LINK ADAPTATION

(71) Applicant: QUALCOMM Incorporated, San Diego, CA (US)

(72) Inventors: Sameer VERMANI, San Diego, CA (US); George CHERIAN, San Diego, CA (US); Alfred ASTERJADHI, San Diego, CA (US); Bin TIAN, San Diego, CA (US); Jialing Li CHEN, San Diego, CA (US); Raj Kumar KRISHNA KUMAR, Bangalore (IN)

(21) Appl. No.: 18/975,927

(22) Filed: Dec. 10, 2024

Related U.S. Application Data
(60) Provisional application No. 63/614,307, filed on Dec. 22, 2023.
(60) Provisional application No. 63/562,432, filed on Mar. 7, 2024.

(51) Int. Cl. H04W 28/18; H04L 5/00; H04W 28/06; H04W 72/23

(52) U.S. Cl. CPC H04W 28/18; H04L 5/0023; H04L 5/0055; H04W 28/06; H04W 72/23

(57) ABSTRACT

This disclosure provides methods, components, devices and systems for communications for fast link adaptation (FLA). In some examples, a transmitter may transmit an FLA information request via a physical layer (PHY) protocol data unit (PPDU). The PPDU may include an FLA information request indicating that the receiver is to report one or more parameter values (such as proposed updates to current parameter values) for a currently used quantity of spatial streams. In some examples, the PPDU may include (such as in a media access control (MAC) header) a bit which can be turned on to request a second FLA element indicating one or more parameters for a proposed (such as, updated) quantity of spatial streams.

### CROSS REFERENCE

The present Application for Patent claims the benefit of U.S. Provisional Patent Application No. 63/614,307 by VERMANI et al., entitled “COMMUNICATIONS FOR FAST LINK ADAPTATION,” filed Dec. 22, 2023, and Patent Application No. 63/562,432 by VERMANI et al., entitled “COMMUNICATIONS FOR FAST LINK ADAPATION,” filed Mar. 7, 2024, each of which is assigned to the assignee hereof and is expressly incorporated by reference herein.

### TECHNICAL FIELD

This disclosure relates generally to wireless communication and, more specifically, to communications for fast link adaptation.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN. In some WLANs, one or more parameters for wireless communications (such as modulation and coding scheme, a quantity of spatial layers, among other examples) may change over time.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an access point (AP). The AP may include a processing system that includes processor circuitry and memory circuitry that stores code. The processing system may be configured to cause the AP to transmit a first physical protocol data unit (PPDU) including a fast link adaptation request message, the fast link adaptation request message including a request for one or more parameter values for a first quantity of spatial streams corresponding to the first PPDU, receive, in accordance with the fast link adaptation request message, a message including a fast link adaptation element, the fast link adaptation element including the one or more parameter values corresponding to the first quantity of spatial streams corresponding to the first PPDU, and transmit a second PPDU according to one or more updated parameters of the second PPDU in accordance with the fast link adaptation element.

Another innovative aspect of the subject matter described in the disclosure can be implemented in a method for wireless communication performable by or at an AP. The method may include transmitting a first PPDU including a fast link adaptation request message, the fast link adaptation request message including a request for one or more parameter values for a first quantity of spatial streams corresponding to the first PPDU, receiving, in accordance with the fast link adaptation request message, a message including a fast link adaptation element, the fast link adaptation element including the one or more parameter values corresponding to the first quantity of spatial streams corresponding to the first PPDU, and transmitting a second PPDU according to one or more updated parameters of the second PPDU in accordance with the fast link adaptation element.

Another innovative aspect of the subject matter described in this disclosure can be implemented in an AP. The AP may include means for transmitting a first PPDU including a fast link adaptation request message, the fast link adaptation request message including a request for one or more parameter values for a first quantity of spatial streams corresponding to the first PPDU, means for receiving, in accordance with the fast link adaptation request message, a message including a fast link adaptation element, the fast link adaptation element including the one or more parameter values corresponding to the first quantity of spatial streams corresponding to the first PPDU, and means for transmitting a second PPDU according to one or more updated parameters of the second PPDU in accordance with the fast link adaptation element.

Another innovative aspect of the subject matter described in this disclosure can be implemented in a non-transitory computer-readable medium storing code for wireless communication at an AP. The code may include instructions executable by one or more processors to transmit a first PPDU including a fast link adaptation request message, the fast link adaptation request message including a request for one or more parameter values for a first quantity of spatial streams corresponding to the first PPDU, receive, in accordance with the fast link adaptation request message, a message including a fast link adaptation element, the fast link adaptation element including the one or more parameter values corresponding to the first quantity of spatial streams corresponding to the first PPDU, and transmit a second PPDU according to one or more updated parameters of the second PPDU in accordance with the fast link adaptation element.

In some examples of the method, APs, and non-transitory computer-readable medium described herein, the fast link adaptation request message includes an indication that a STA may be to report a second fast link adaptation element corresponding to a second quantity of spatial streams that may be different than the first quantity of spatial streams.

In some examples of the method, APs, and non-transitory computer-readable medium described herein, the first PPDU includes a numerical quantity of long training fields that may be greater than or equal to the second quantity of spatial streams.

In some examples of the method, access points APs, and non-transitory computer-readable medium described herein, the first PPDU includes a first indication of the first quantity of spatial streams, and a second indication of a quantity of additional spatial streams, a sum of the first quantity of spatial streams and the quantity of additional spatial streams being greater than or equal to the second quantity of spatial streams.

In some examples of the method, access points APs, and non-transitory computer-readable medium described herein, the one or more parameter values in the fast link adaptation element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

In some examples of the method, APs, and non-transitory computer-readable medium described herein, a second fast link adaptation element includes an indication of a proposed second quantity of spatial streams different than the first quantity of spatial streams, a third modulation and coding scheme corresponding to the proposed second quantity of spatial streams, a third signal to noise ratio margin corresponding to the third modulation and coding scheme, a fourth signal to noise ratio margin corresponding to a fourth modulation and coding scheme, a second indication to drop one or more of the first quantity of spatial streams, or any combination thereof.

In some examples of the method, APs, and non-transitory computer-readable medium described herein, unequal modulation may be enabled and the one or more parameter values includes an indication of a first modulation and coding scheme corresponding to a first spatial stream of the first quantity of spatial streams.

In some examples of the method, APs, and non-transitory computer-readable medium described herein, the fast link adaptation element includes a set of multiple offsets from a first signal to interference and noise ratio (SINR) corresponding to the first modulation and coding scheme, each offset of the set of multiple offsets corresponding to a respective spatial stream of a remainder of the first quantity of spatial streams.

In some examples of the method, APs, and non-transitory computer-readable medium described herein, the fast link adaptation element includes a set of multiple offsets from the first modulation and coding scheme, each offset of the set of multiple offsets corresponding to a respective spatial stream of a remainder of the first quantity of spatial streams.

In some examples of the method, APs, and non-transitory computer-readable medium described herein, the first quantity of spatial streams may be indicated in a descending order of signal to SINR, the first spatial stream of the first quantity of spatial streams having a lowest SINR and the indication of the first modulation and coding scheme corresponding to the first spatial stream of the first quantity of spatial streams may be in accordance with the first spatial stream having the lowest SINR.

In some examples of the method, APs, and non-transitory computer-readable medium described herein, unequal modulation may be enabled and the one or more parameter values includes an indication of a first SINR corresponding to a first spatial stream of the first quantity of spatial streams.

In some examples of the method, APs, and non-transitory computer-readable medium described herein, the fast link adaptation element includes a first modulation and coding scheme corresponding to the first spatial stream, and a set of multiple offsets from the first SINR, each offset of the set of multiple offsets corresponding to a respective spatial stream of a remainder of the first quantity of spatial streams.

In some examples of the method, APs, and non-transitory computer-readable medium described herein, the fast link adaptation element includes a first modulation and coding scheme corresponding to the first spatial stream, and a set of multiple modulation gaps from the first modulation and coding scheme, each modulation gap of the set of multiple modulation gaps corresponding to a respective spatial stream of a remainder of the first quantity of spatial streams.

In some examples of the method, APs, and non-transitory computer-readable medium described herein, the PPDU may be transmitted via a numerical quantity of spatial streams that may be greater than or equal to the first quantity of spatial streams, each spatial stream of the numerical quantity of spatial streams corresponding to a respective modulation and coding scheme of a set of multiple modulation and coding schemes.

In some examples of the method, APs, and non-transitory computer-readable medium described herein, the one or more parameter values for the first quantity of spatial streams corresponding to the first PPDU includes one or more proposed updates to be applied to a current set of parameter values corresponding to the first quantity of spatial streams and the first PPDU.

Another innovative aspect of the subject matter described in this disclosure can be implemented in a wireless device. The wireless device may include a processing system that includes processor circuitry and memory circuitry that stores code. The processing system may be configured to cause the wireless device to receive a first PPDU including a fast link adaptation request message, the fast link adaptation request message including a request for one or more parameter values for a first quantity of spatial streams corresponding to the first PPDU, transmit, in accordance with the fast link adaptation request message, a message including a fast link adaptation element, the fast link adaptation element including the one or more parameter values for the first quantity of spatial streams corresponding to the first PPDU, and receive a second PPDU according to one or more updated parameters of the second PPDU in accordance with the fast link adaptation element.

Another innovative aspect of the subject matter described in the disclosure can be implemented in a method for wireless communication performable by or at a wireless device. The method may include receiving a first PPDU including a fast link adaptation request message, the fast link adaptation request message including a request for one or more parameter values for a first quantity of spatial streams corresponding to the first PPDU, transmitting, in accordance with the fast link adaptation request message, a message including a fast link adaptation element, the fast link adaptation element including the one or more parameter values for the first quantity of spatial streams corresponding to the first PPDU, and receiving a second PPDU according to one or more updated parameters of the second PPDU in accordance with the fast link adaptation element.

Another innovative aspect of the subject matter described in this disclosure can be implemented in a wireless device. The wireless device may include means for receiving a first PPDU including a fast link adaptation request message, the fast link adaptation request message including a request for one or more parameter values for a first quantity of spatial streams corresponding to the first PPDU, means for transmitting, in accordance with the fast link adaptation request message, a message including a fast link adaptation element, the fast link adaptation element including the one or more parameter values for the first quantity of spatial streams corresponding to the first PPDU, and means for receiving a second PPDU according to one or more updated parameters of the second PPDU in accordance with the fast link adaptation element.

Another innovative aspect of the subject matter described in this disclosure can be implemented in a non-transitory computer-readable medium storing code for wireless communication at a wireless device. The code may include instructions executable by one or more processors to receive a first PPDU including a fast link adaptation request message, the fast link adaptation request message including a request for one or more parameter values for a first quantity of spatial streams corresponding to the first PPDU, transmit, in accordance with the fast link adaptation request message, a message including a fast link adaptation element, the fast link adaptation element including the one or more parameter values for the first quantity of spatial streams corresponding to the first PPDU, and receive a second PPDU according to one or more updated parameters of the second PPDU in accordance with the fast link adaptation element.

In some examples of the method, wireless devices, and non-transitory computer-readable medium described herein, the fast link adaptation request message includes an indication that the wireless device may be to report a second fast link adaptation element corresponding to a second quantity of spatial streams that may be different than the first quantity of spatial streams.

In some examples of the method, wireless devices, and non-transitory computer-readable medium described herein, the first PPDU includes a numerical quantity of long training fields that may be greater than or equal to the second quantity of spatial streams.

In some examples of the method, wireless devices, and non-transitory computer-readable medium described herein, the first PPDU includes a first indication of the first quantity of spatial streams, and a second indication of a quantity of additional spatial streams, a sum of the first quantity of spatial streams and the quantity of additional spatial streams being greater than or equal to the second quantity of spatial streams.

In some examples of the method, wireless devices, and non-transitory computer-readable medium described herein, the first PPDU includes an instruction to perform one or more measurements on at least one of the quantity of additional spatial streams.

Some examples of the method, wireless devices, and non-transitory computer-readable medium described herein may further include operations, features, means, or instructions for performing a first set of measurements according to the request for one or more parameter values for the first quantity of spatial streams corresponding to the first PPDU and performing the one or more measurements according to the instruction based on the first quantity of spatial streams and the at least one of the quantity of additional spatial streams.

Some examples of the method, wireless devices, and non-transitory computer-readable medium described herein may further include operations, features, means, or instructions for generating the fast link adaptation element corresponding to the first set of measurements and a second fast link adaptation element corresponding to the one or more measurements, the MBA message including the fast link adaptation element and the second fast link adaptation element.

In some examples of the method, wireless devices, and non-transitory computer-readable medium described herein, the one or more parameter values in the fast link adaptation element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

In some examples of the method, wireless devices, and non-transitory computer-readable medium described herein, a second fast link adaptation element includes an indication of a proposed second quantity of spatial streams different than the first quantity of spatial streams, a third modulation and coding scheme corresponding to the proposed second quantity of spatial streams, a third signal to noise ratio margin corresponding to the second modulation and coding scheme, a fourth signal to noise ratio margin corresponding to a fourth modulation and coding scheme, a second indication to drop one or more of the first quantity of spatial streams, or any combination thereof.

In some examples of the method, wireless devices, and non-transitory computer-readable medium described herein, unequal modulation may be enabled and the one or more parameter values includes an indication of a first modulation and coding scheme corresponding to a first spatial stream of the first quantity of spatial streams.

In some examples of the method, wireless devices, and non-transitory computer-readable medium described herein, the fast link adaptation element includes a set of multiple offsets from a first SINR corresponding to the first modulation and coding scheme, each offset of the set of multiple offsets corresponding to a respective spatial stream of a remainder of the first quantity of spatial streams.

In some examples of the method, wireless devices, and non-transitory computer-readable medium described herein, the fast link adaptation element includes a set of multiple offsets from the first modulation and coding scheme, each offset of the set of multiple offsets corresponding to a respective spatial stream of a remainder of the first quantity of spatial streams.

In some examples of the method, wireless devices, and non-transitory computer-readable medium described herein, the first quantity of spatial streams may be indicated in a descending order of SINR, the first spatial stream of the first quantity of spatial streams having a lowest SINR and the indication of the first modulation and coding scheme corresponding to the first spatial stream of the first quantity of spatial streams may be in accordance with the first spatial stream having the lowest SINR.

In some examples of the method, wireless devices, and non-transitory computer-readable medium described herein, unequal modulation may be enabled and the one or more parameter values includes an indication of a first SINR corresponding to a first spatial stream of the first quantity of spatial streams.

In some examples of the method, wireless devices, and non-transitory computer-readable medium described herein, the fast link adaptation element includes a first modulation and coding scheme corresponding to the first spatial stream, and a set of multiple offsets from the first SINR, each offset of the set of multiple offsets corresponding to a respective spatial stream of a remainder of the first quantity of spatial streams.

In some examples of the method, wireless devices, and non-transitory computer-readable medium described herein, the fast link adaptation element includes a first modulation and coding scheme corresponding to the first spatial stream, and a set of multiple modulation gaps from the first modulation and coding scheme, each modulation gap of the set of multiple modulation gaps corresponding to a respective spatial stream of a remainder of the first quantity of spatial streams.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network that supports fast link adaptation (FLA) requests and FLA feedback between transmitter and receiver devices.

FIG. 2 shows an example physical layer (PHY) protocol data unit (PPDU) usable for communications between a wireless access point (AP) and one or more wireless stations (STAs), where the PPDU may carry an FLA information request message.

FIG. 3 shows a hierarchical format of an example PPDU usable for communications between a wireless AP and one or more wireless STAs, where the PPDU may carry an FLA information request message, and an indication of one or more additional FLA elements.

FIG. 4 shows a pictorial diagram of another example wireless communication network that supports FLA feedback between transmitter and receiver devices.

FIG. 5 shows an example of a timeline that supports communications for fast link adaptation, where a PPDU carries an FLA information request message, and a multi-STA block acknowledgment (MBA) message carries one or more FLA elements including FLA feedback information.

FIG. 6 shows an example of a PPDU that supports communications for fast link adaptation, where the PPDU includes additional long training fields (LTFs) and an indication of additional spatial streams for measurement and FLA reporting.

FIG. 7 shows an example of an enhanced multi-STA acknowledgement (eMBA) that supports communications for fast link adaptation and carries one or more FLA elements responsive to an FLA information message request.

FIG. 8 shows an example of a timeline that supports communications for fast link adaptation, where beamforming reports (BFR), or eMBAs carry FLA feedback information.

FIG. 9 shows an example of a timeline that supports communications for fast link adaptation), where eMBAs carry FLA feedback information responsive to FLA information requests carried via a null data packet (NDP).

FIG. 10 shows an example of a timeline that supports communications for fast link adaptation), enhanced clear to send (eCTS) messages carry FLA feedback information responsive to FLA information requests carried via an NDP or enhanced request to send (eRTS) messages.

FIG. 11 shows an example of a timeline that supports communications for fast link adaptation), where enhanced clear to send (eCTS) messages carry FLA feedback information responsive to FLA information requests carried via enhanced request to send (eRTS) messages.

FIG. 12 shows an example of a timeline that supports communications for fast link adaptation enhanced clear to send (eCTS) messages carry FLA feedback information responsive to FLA information requests carried via an enhanced request to send (eRTS) message.

FIG. 13 shows a block diagram of an example wireless communication device that supports communications for fast link adaptation.

FIG. 14 shows a block diagram of an example wireless communication device that supports communications for fast link adaptation.

FIG. 15 shows a flowchart illustrating an example process performable by or at an access point (AP) that supports communications for fast link adaptation.

FIG. 16 shows a flowchart illustrating an example process performable by or at a station (STA) that supports communications for fast link adaptation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to requesting and reporting fast link adaptation (FLA) information. Some aspects more specifically relate to a FLA request, transmitted via a physical layer (PHY) protocol data unit (PPDU), and one or more responsive FLA elements (such as transmitted via a multi-STA block acknowledgment (MBA) message, such as an enhanced MBA (eMBA)). In some examples, a transmitter (such as an AP) may transmit an FLA request via a PPDU. The PPDU may include an FLA request indicating that the receiver (the STA) is to report one or more parameter values (such as proposed updates to current parameter values) for a currently used quantity of spatial streams. For example, the transmitter may transmit the PPDU using a quantity of spatial streams, and may request that the receiver provide an FLA element indicating a best or proposed modulation and coding scheme (MCS), among other parameter values, for subsequent communications using the same quantity of spatial streams. In some examples, the PPDU may include (such as in a media access control (MAC) header) a bit which can be set to request a second FLA element indicating one or more parameters for a proposed (such as, an optimal) quantity of spatial streams. In such examples, the receiver may receive the PPDU via a first quantity of spatial streams, but may be instructed to indicate a proposed MCS or other parameters for a second (such as, a greater) quantity of spatial streams. In such examples, the PPDU may include an indication of one or more additional streams, and may further include additional long training fields (LTFs) for the receiver to use for measuring the additional spatial streams and reporting the requested FLA information.

Particular aspects of the subject matter described in this disclosure can be implemented to realize one or more of the following potential advantages. In some examples, by transmitting the FLA request and receiving the one or more FLA elements, the described techniques can be used to exchange FLA information, resulting in more rapid and effective adjustments to subsequent communications via a wireless link. Such fast adaptations to wireless communications may result in increased throughput and decreased system latency, which may support better power management, improved user experience, and greater spectral efficiency. Further, by transmitting the FLA request via a PPDU (instead of via another message, such as a request to send, or a control frame), the transmission of the FLA request may be performed via multiple spatial streams, providing multiple spatial streams for measurement by the receiving device and more robust FLA information in an FLA report. Further, techniques described herein support an increased quantity of long training fields (LTFs) for performing measurements on additional spatial streams, indications of the additional spatial streams, and more robust measurements and reporting of FLA information by the receiving device resulting in an increase in the quantity and quality of FLA information reported by the receiving device, and more dynamic capacity by the transmitter to adjust subsequent transmissions according to the high quality FLA information provided by the receiving device.

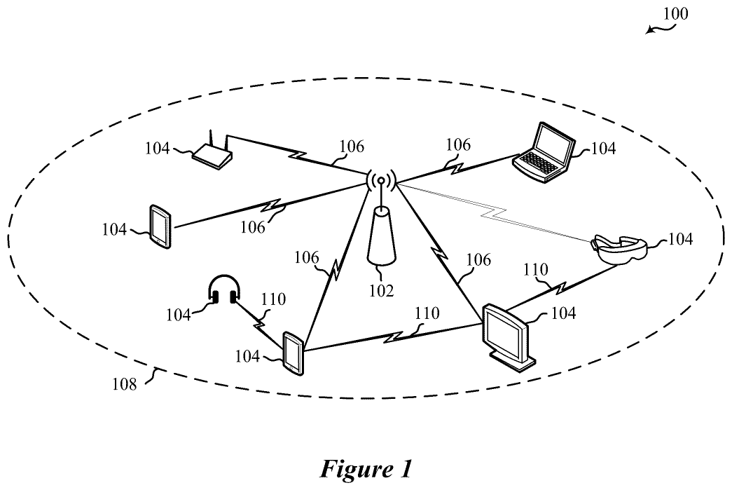

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHz-52.6 GHz), FR3 (7.125 GHz-24.25 GHz), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Further, as described herein, the terms “channel” and “subchannel” may be used interchangeably, and each may refer to a portion of a frequency spectrum via which communication between two or more wireless communication devices can be allocated. For example, a channel or subchannel may refer to a discrete portion (such as a discrete amount, span, range, or subset) of frequency of an operating bandwidth. A channel or subchannel may refer to a 20 MHz portion, a 40 MHz portion, an 80 MHz portion, or a 160 MHz portion, among other examples. In other words, a channel or subchannel may include one or more 20 MHz channels. A primary channel or subchannel may be understood as a portion of a frequency spectrum that includes a primary 20 MHz used for beaconing, among other (management) frame transmissions. A secondary channel or subchannel may be understood as a portion of a frequency spectrum that excludes the primary 20 MHz (or that at least excludes a main primary (M-Primary) channel). In some systems, a secondary channel or subchannel may include an opportunistic primary (O-Primary) channel. A wireless communication device may use an M-Primary channel (such as an M-Primary 20 MHz) for beaconing and/or serving legacy clients and may use an O-Primary channel (such as an O-Primary 20 MHz) for opportunistic access on one or more other channels (such as if the M-Primary channel is busy or occupied).

In some aspects, different portions of a frequency spectrum (such as a 40 MHz portion, an 80 MHz portion, or a 160 MHz portion) may be associated with multiple (20 MHz) subchannels and at least one anchor subchannel. In such aspects, an anchor subchannel may define, indicate, or identify a lowest (20 MHz) subchannel within a given portion of a frequency spectrum. For example, a first anchor subchannel may define, indicate, or identify a lowest 20 MHz subchannel within a secondary 40 MHz bandwidth, a second anchor subchannel may define, indicate, or identify a lowest 20 MHz subchannel within a secondary 80 MHz bandwidth, and a third anchor subchannel may define, indicate, or identify a lowest 20 MHz subchannel within a secondary 160 MHz bandwidth. In some aspects, a wireless communication device may use an anchor subchannel as an O-Primary channel.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHZ bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

In some examples, a transmitter (such as an AP 102 or a STA 104) may transmit an FLA request via a PPDU. The PPDU may include an FLA request indicating that the receiver (the STA 104 or the AP 102) is to report one or more parameter values (such as proposed updates to current parameter values) for a currently used quantity of spatial streams. For example, the transmitter may transmit the PPDU using a quantity of spatial streams, and may request that the receiver provide an FLA element indicating a best or proposed modulation and coding scheme (MCS), among other parameter values, for subsequent communications using the same quantity of spatial streams. In some examples, the PPDU may include (such as in the MAC header) a bit which can be turned on to request a second FLA element indicating one or more parameters for a proposed quantity of spatial streams. In such examples, the receiver may receive the PPDU via a first quantity of spatial streams, but may be instructed to indicate a proposed MCS or other parameters for a second (such as, a greater) quantity of spatial streams. In such examples, the PPDU may include an indication of one or more additional streams, and may further include additional long training fields (LTFs) for the receiver to use for measuring the additional spatial streams and reporting the requested FLA information.

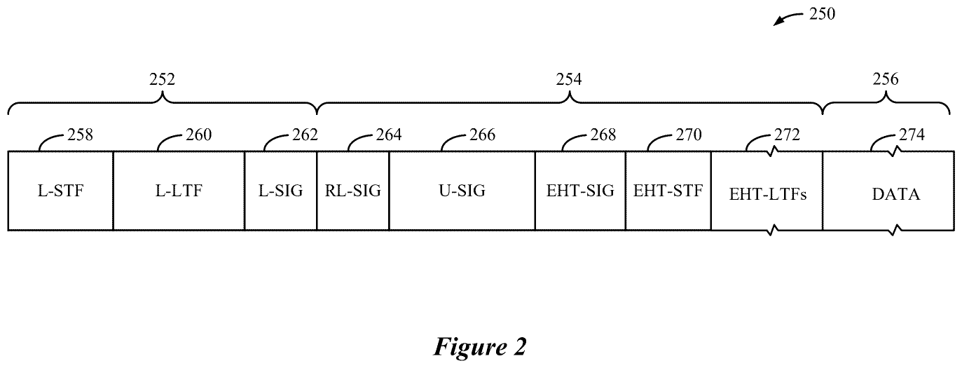

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT- or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as the AP 102 or the STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (such as STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some examples, a transmitter (such as an AP 102 or a STA 104) may transmit an FLA request via a PPDU, such as the PPDU 250. The PPDU may include an FLA request indicating that the receiver (the STA 104 or the AP 102) is to report one or more parameter values (such as proposed updates to current parameter values) for a currently used quantity of spatial streams. The FLA request may be included in a field such as an EHT SIG 268, or an ultra-high reliability (UHR) SIG. The transmitter may transmit the PPDU 250 using a quantity of spatial streams, and may request that the receiver provide an FLA element indicating a best or proposed modulation and coding scheme (MCS), among other parameter values, for subsequent communications using the same quantity of spatial streams. The PPDU 250 may further include multiple (such as, additional) EHT-LTFs, for performing measurements and reporting additional FLA elements (such as, if requested in the MAC header of the PPDU 250).

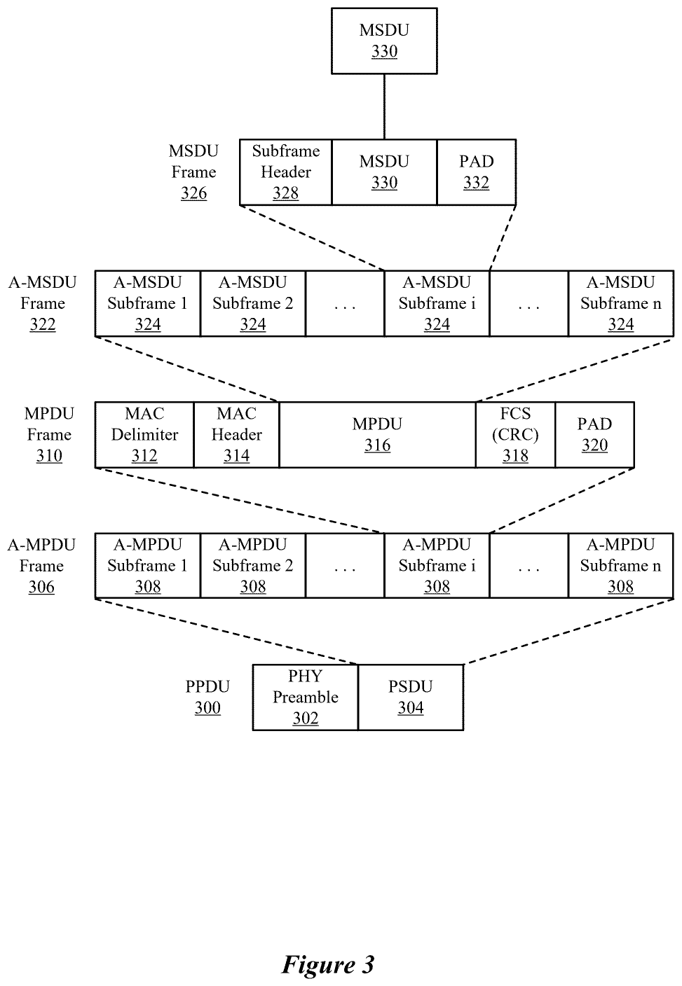

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with (such as an example of or otherwise referred to as) an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

APs and STAs (such as the AP 102 and the STAs 104 described with reference to FIG. 1) that include multiple antennas may support various diversity schemes. For example, spatial diversity may be used by one or both of a transmitting device (such as either an AP 102 or a STA 104) or a receiving device (such as either an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, power level, among other examples, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. To mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some wireless communication devices (including both APs and STAs such as, for example, AP 102 and STAs 104 described with reference to FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. Additionally, or alternatively, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHZ band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

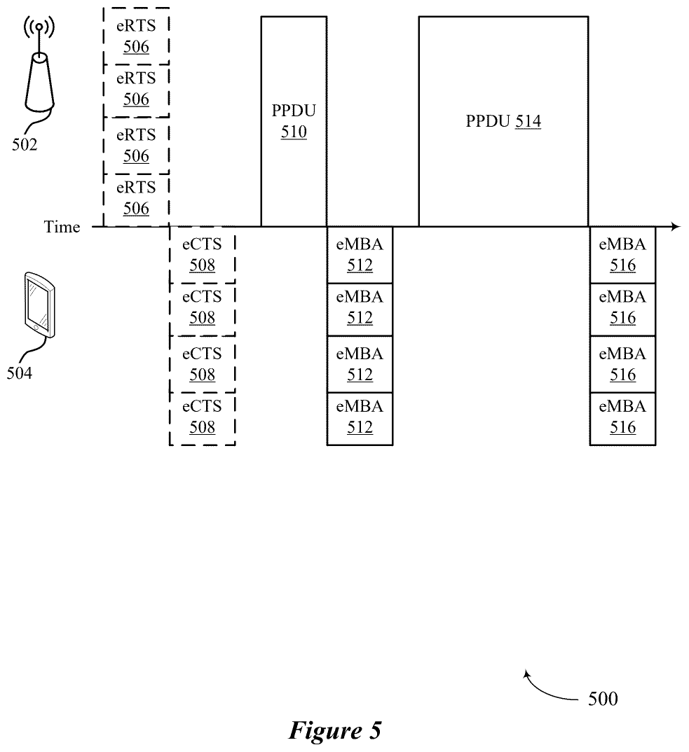

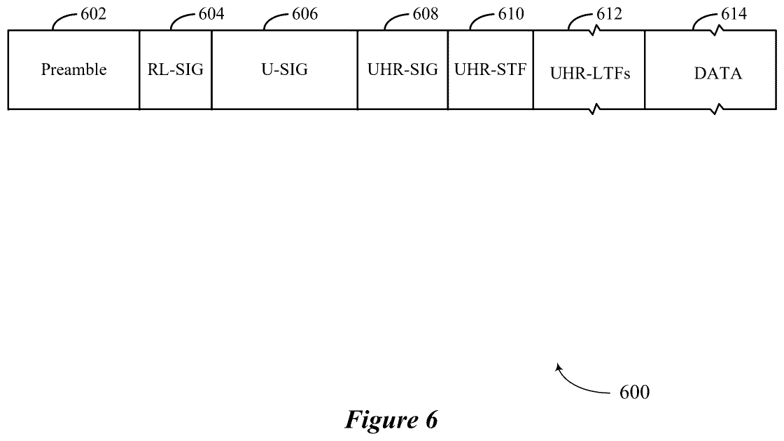

In some examples, a transmitter (such as an AP 102 or a STA 104) may transmit an FLA request via a PPDU, such as the PPDU 300. The PPDU may include an FLA request indicating that the receiver (the STA 104 or the AP 102) is to report one or more parameter values (such as proposed updates to current parameter values) for a currently used quantity of spatial streams. The transmitter may transmit the PPDU 300 using a quantity of spatial streams, and may request that the receiver provide an FLA element indicating a best or proposed modulation and coding scheme (MCS), among other parameter values, for subsequent communications using the same quantity of spatial streams. The PPDU 300 also may include an indication in a MAC header (such as the MAC header 314) request one or more additional FLA elements, as described in greater detail with reference to FIG. 5 and FIG. 6.

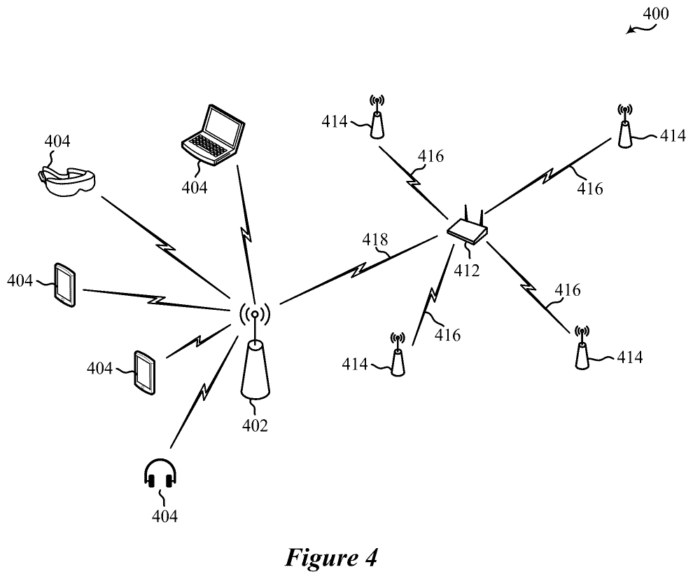

FIG. 4 shows a pictorial diagram of another example wireless communication network 400. According to some aspects, the wireless communication network 400 can be an example of a mesh network, an IoT network, or a sensor network in accordance with one or more of the IEEE 802.11 family of wireless communication protocol standards (including the 802.11ah amendment). The wireless communication network 400 may include multiple wireless communication devices 414, which in some implementations may include APs 402, STAs 404, or both. The wireless communication devices 414 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (such as audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a wireless communication network 100 or a wireless (such as cellular) wide area network (WWAN), which may, in turn, provide access to external networks including the Internet. For example, the intermediate device 412 may associate and communicate, over a Wi-Fi link 418, with an AP 102 of a WLAN network, which also may serve various STAs 104. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

In some examples, a transmitter (such as an AP 402 or a STA 404, among other examples) may transmit an FLA request via a PPDU. The PPDU may include an FLA request indicating that the receiver (the STA 404 or the AP 402) is to report one or more parameter values (such as proposed updates to current parameter values) for a currently used quantity of spatial streams. The transmitter may transmit the PPDU using a quantity of spatial streams, and may request that the receiver provide an FLA element indicating a best or preferred modulation and coding scheme (MCS), among other parameter values, for subsequent communications using the same quantity of spatial streams. The PPDU may further include multiple (such as, additional) LTFs, for performing measurements and reporting additional FLA elements (such as, if requested by the PPDU).

FIG. 5 shows an example of a timeline 500 that supports communications for fast link adaptation. The timeline 500 may implement aspects of, or be implemented by aspects of, the pictorial diagram of the example wireless communication network 100, the example PPDU 250, the PPDU 300, and the example wireless communication network 400. For example, a transmitting device (such as the AP 502) and a receiving device (such as a STA 504), which may be examples of corresponding devices described with reference to FIGS. 1-4, may communicate with each other according to the timeline 500. Techniques described herein may be performed between any transmitting and receiving device (such as a transmitting STA 504 and a receiving AP 502, or a transmit AP 502 and a receiving STA 504, as illustrated with reference to FIG. 5).

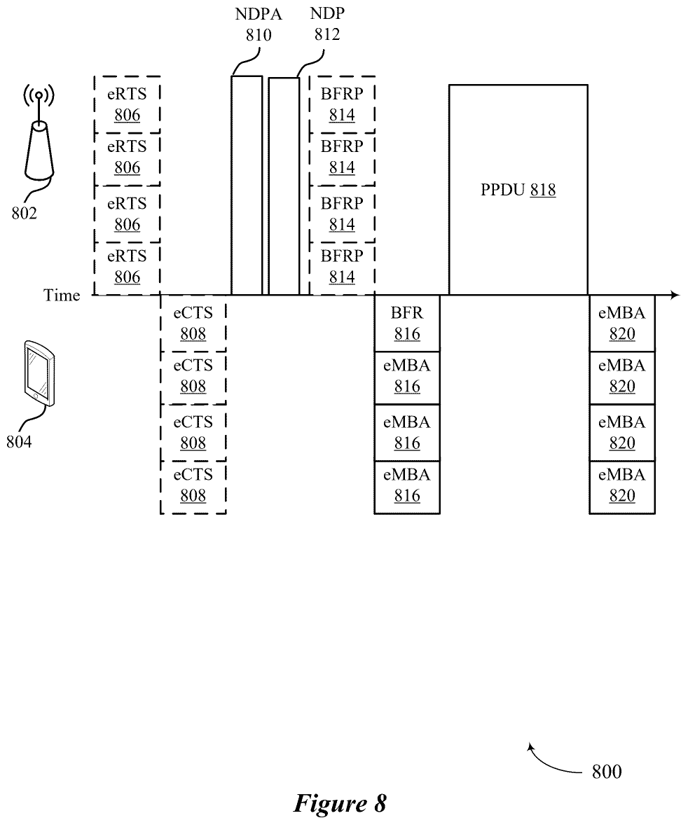

In some examples, the AP 502 and the STA 504 for support FLA. For example, a receiver (such as the STA 504) may recommend one or more parameters (such as MCS, or other link quality parameters) for subsequent communications. As described herein, the transmitter (such as the AP 502) may transmit an FLA request, and the receiver (such as the STA 504) may transmit one or more FLA elements in response to the FLA request. In some examples, the AP 502 may transmit the FLA request via a PPDU 510. In some examples, the PPDU 510 may be a data PPDU. In some examples, as described in greater detail with reference to FIGS. 8-12, the FLA request may be included in a request to send (RTS), enhanced RTS (CRTS), or another control frame, among other examples. In response to the FLA information, the STA 504 may transmit a control response including the FLA feedback. In some examples, the FLA feedback (such as one or more FLA elements) may be included in an MBA (such as an eMBA 512). In some examples, the FLA feedback may be included in a clear to send (CTS) message, an enhanced CTS (eCTS), or another message, as described in greater detail with reference to FIGS. 8-12.

With reference to FIG. 5, the AP 502 may transmit one or more eRTSs 506, and the STA 504 may transmit one or more eCTSs 508 (in response to the eRTSs). In some examples, the eRTSs 506 and the eCTSs 508 may be utilized for non-FLA operations.

The AP 502 may transmit a first PPDU (such as the PPDU 510) including an FLA request message. The FLA request message may include a request for one or more parameter values for a first quantity of spatial streams corresponding to the PPDU 510. In some examples, the PPDU 510 may be an HE PPDU, an EHT PPDU, or a UHR PPDU, among other examples. The PPDU 510 may include a quality of service null packet, or a small packet. In some examples, the PPDU 510 may be smaller than (such as may include less data or less content) than the PPDU 514. CQI may be performed on a preamble of the PPDU 510. In some examples, a PSDU of the PPDU 510 may be transmitted using a robust MCS. The PPDU 510 and the eMBAs 512 may be used for FLA operations (such as exchanging the FLA request and the FLA elements). The PPDU 510 may be transmitted via a first quantity of spatial streams (such as number of spatial streams (NSS) indicated in the PPDU, as described in greater detail with reference to FIG. 6.

In some examples, the PPDU 510 may include an indication that the STA 504 is to report a second FLA element corresponding to a second quantity of spatial streams that is different than the first quantity of spatial streams used for transmission of the PPDU 510. For instance, a MAC header (such as the MAC header 314 described with reference to FIG. 3) may include an indication (such as a bit) requesting additional FLA information for a proposed (such as, an optimal) number of streams. That is, the AP 502 may transmit the FLA request, which may request FLA feedback (such as a first FLA element) for the quantity of spatial streams used to transmit the PPDU. Such an FLA element (which may be transmitted via one or more eMBAs 512) may indicate a proposed updated MCS for the first quantity of spatial streams used to transmit the PPDU. The STA 504 may perform measurements (such as using one or more LTFs of the PPDU 510) to determine a proposed (such as, a best) MCS for the first quantity of spatial streams. In addition to the FLA information for the first quantity of streams in the data section of the PPDU 510, the one-bit indicator in the MAC header of the PPDU 510 may request FLA information for a different (such as a proposed) quantity of streams. For example, the PPDU 510 may be transmitted using four spatial streams. However, the STA 504 may determine that subsequent PPDUs could be transmitted using a higher quantity (such as, six or eight) of spatial streams (such as using the same MCS, or a different proposed MCS). In such examples, the eMBAs 512 may include more than one FLA element for a user (a first FLA for the quantity of spatial streams used to transmit the PPDU 510, and a second FLA for the additional proposed quantity of streams).

To enable the second FLA element, a greater quantity of LTFs than the number of space time streams (Nsts) of the data section may be sent by the AP 502 to allow the STA 504 to calculate the FLA information needed for a greater number of streams than the Nsts. The WLAN system may support additional quantities of LTFs (without any restrictions in any standards documents), or the AP 502 may support an increased quantity of LTFs up to a threshold quantity of LTFs. In some examples, an extended number of streams may be supported by the AP 502, and may be indicated to the STA 504, as described in greater detail with reference to FIG. 6. In such examples, the PPDU 510 may include a numerical quantity of LTFs that is greater than or equal to the second quantity of spatial streams that the STA 504 reports in the second FLA element. The PPDU 510 may include an indication of one or more additional spatial streams (the extended number of streams).

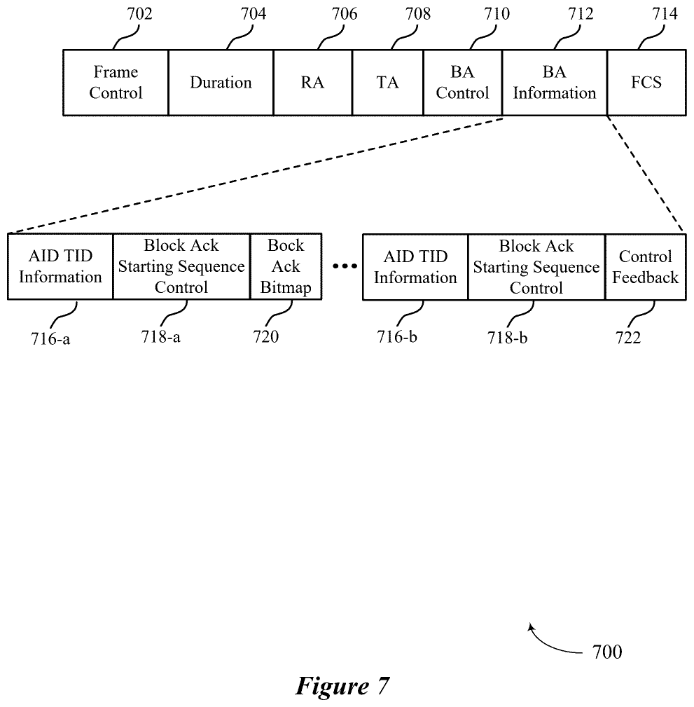

The STA 504 may transmit, in accordance with the FLA request message, an MBA message (such as one or more eMBAs 512). A first FLA elements in the MBA message may include one or more parameter values corresponding to the first quantity of spatial streams for the first PPDU. A second FLA element (or multiple additional FLA elements) may correspond to a second quantity of spatial streams (such as more spatial streams than the first quantity of spatial streams used to transmit the PPDU 510). The one or more FLA elements may be included in one or more fields (such as control feedback in a block ack (BA) information field) as described in greater detail with reference to FIG. 7. Each FLA element may include one or more parameter values. For example, each FLA element may include an MCS (such as a recommended MCS for the reported quantity of spatial streams), an indication of Nss (such as a quantity of spatial streams). The Nss indicator may be used to carry the number of streams in the measurement packet (such as, the first FLA element may include an Nss equal to the first quantity of streams used for the PPDU 510), or may serve as a rank recommendation (such as, the second FLA may include a proposed rank indicated by the Nss indicator).

The FLA element may include an SNR margin or signal to interference and noise ratio (SINR) margin (such as, to the recommended MCS level). Such an indication of an SNR or SINR margin may be helpful information in case the transmitter (such as the AP 502) makes a transmit power adjustment for the proposed quantity of spatial streams indicated in the second FLA element. The SNR margin or SINR margin may be indicated using a small quantity of bits (such as one, two, or three bits), because a gap between adjacent MCSs may be relatively small (such as four to five decibels). The SNR margin or the SINR margin may be indicative of a next highest MCS or a next lowest MCS. For example, a measured SNR or SINR may not directly correspond to an MCS, but rather by be between an MCS corresponding to a higher SNR or SINR, and an MCS corresponding to a lower SNR or SINR. The SNR margin or SINR margin may indicate an offset from a measured SNR or SINR to a first MCS (such as an MCS corresponding to a higher SINR or SNR) or a second MCS (such as an MCS corresponding to a lower SINR or SNR), or both. Each FLA element may include an indication to drop an Nss (such as an indication to decrease a quantity of spatial streams, an indication to drop specific spatial streams, an indication to drop all current spatial streams, or the like).

In some examples, the FLA element may include an indication of a per-stream SINR margin. The per-stream SINR margin may support transmit power adjustments by the transmitter, reliability improvement, rank adjustment, QAM pattern adjustments, or any combination thereof. The per-stream SINR margin may be indicated as a negative number (such as, for streams other than the strongest stream). For example, for a given configuration (such as, a given Nss, anchor MCS, QAM pattern, etc.), the receiver may calculate an effective SINR per stream, and may compare the effective SINR per stream to a threshold (such as a required) effective SINR for that stream to decode with a reasonable error rate. The difference between the two quantities (such as, the calculated effective SINR per stream and the threshold effective SINR for the respective stream) may define the SINR margin per stream. The per-stream margin of a quantity of dB (such as, X dB) may provide relevant information to the transmitter. For instance, a per-stream margin of X dB where X is positive may indicate that the transmitter may reduce the transmit power by X dB, and the recommended QAM level will still go through on that stream with a reasonable error rate. A highly positive value of X dB may indicate that the QAM level may be upwards adjusted on an indicated stream. A small positive value of X may be ideal (such as, indicating a highly efficient or effective SINR margin), and may indicate a good current QAM selection for the indicated stream. A highly negative value of X may indicate that the QAM level should be downward adjusted, or that a transmission rank should be reduced. A small negative value of X may be possible when a stream is getting help from another stream (such as, via joint coding) to go through successfully.

The FLA elements may be one of various types of FLA element. For example, a first FLA element type may correspond to an existing transmission configuration (such as, a current quantity of spatial streams corresponding to the PPDU 510). In some examples (for example, the first FLA element type), the FLA element may be sent via a BA frame (such as, when requested by the transmitter). The first type of FLA element may include a recommended, or anchor, MCS (such as, for a strongest stream) for one or more parameters (such as, an Nss, or QAM pattern) of a requesting packet. The FLA element may include a per-stream SINR margin for supporting the MCS corresponding to the requesting packet.

A second FLA element type may correspond to a proposed (or optimal) configuration (such as a proposed quantity of spatial streams). In some examples, the AP 502 may turn a request for the second FLA element type on or off (such as, via a one-bit indicator that is turned on or off in the MAC header of the PPDU 510). In some examples, the FLA element may be transmitted in a sounding sequence (such as, when requested in a null data packet announcement (NDPA)). For example, the FLA element for an optimal configuration may be sent during a sounding phase of wireless communications in a sounding feedback packet. In some examples, when an FLA element (such as, the second FLA element type) is being requested in a sounding sequence, a beamforming report poll frame may be transmitted (such as, to ensure sufficient time to the receiver to complete FLA calculations). In some examples, FLA elements of the second type may or may not be supported based on timelines for calculating FLA information in SIFS, and multiple hypothesis (such as, for different quantities of streams) for evaluation. The FLA element may include an Nss recommendation, a QAM pattern recommendation, or both, a recommended, or anchor, MCS (such as, for a strongest stream), for the recommended parameters (for the recommended Nss, or QAM pattern). The FLA element may include a per-stream SINR margin for supporting the recommended MCS.

The AP 502 may perform subsequent communications with the STA 504 based on the FLA information reported by the STA 504. For example, the AP 502 may transmit the PPDU 514 according to the updated parameters based on the FLA information received from the STA 504 via the eMBAs 512. In some examples, the AP 502 may occasionally request the second type of FLA information (such as the second FLA element type) occasionally, and may more regularly request the first type of FLA information (such as the first FLA element type). For instance, the PPDU 510 may include a request for the first type of FLA information (such as, for the current transmission configuration used for the PPDU 510), and also may include a request (such as, a one-bit indicator) for the second type of FLA information (such as, a proposed transmission configuration). The AP 502 may transmit the PPDU 514, which may be a data PPDU and may include more content than the PPDU 510. The PPDU 514 may include a request for the first type of FLA information, but may not include a request for the second type of FLA information. The STA 504 may provide the first type of FLA information (such as, the first type of FLA element) in one or more eMBAs 516.

In some examples, wireless communications (such as, UHR communications) may support unequal modulation. In such examples, the transmitter (such as, the AP 502) may use different modulations (such as, different MCSs) for different spatial streams. For instance, the AP 52 may transmit the PPDU 510 via the first quantity of spatial streams, and may use different MCSs for each spatial stream.

In some examples where unequal modulation (UEQM) is enabled, such as a transmission beamformer deployment, spatial streams may be ordered in descending order (such as, from best SINR to worst SINR). In such examples, the FLA feedback transmitted by the STA 504 may include an indication of Nss (such as, a quantity of streams reported in the FLA element) and an MCS of the best stream (such as, the spatial stream with the best SINR). For all other streams, the FLA feedback information may include offsets (such as, delta values) from the best SINR, to the lower SINRs of the respective additional streams. For example, in the scenario of two spatial streams, an FLA element may indicate an MCS for the first spatial stream (such as, the best spatial stream), and an offset (such as, delta_1) from the SINR of the first stream to the SINR of the second spatial stream. The AP 502 may determine an MCS for the second spatial stream based on the offset. In the scenario of three spatial streams, the FLA element may indicate an MCS for the first spatial stream (such as, the best spatial stream), and a first offset (such as, delta_1) from the SINR of the first spatial stream to the SINR of the second spatial stream, and a second offset (such as, delta_2) from the SINR of the first spatial stream to the SINR of the second spatial stream. In some examples, the FLA feedback information may include an indication of the MCS of the first stream and which UEQM pattern to use, and an indication of certain patterns for Nss values. For example, the FLA feedback information may include an MCS for the first spatial stream, and an offset (such as, an offset defined in the specification) from the MCS of the first spatial stream. For instance, for a two spatial stream scenario, the FLA feedback information may indicate a baseline or default QAM (such as QAM 256), and may indicate (QAM, QAM-1) and (QAM, QAM-2) for the two streams, which may indicate a first MCS for the first spatial stream (such as, 64 QAM, which is a first MCS lower than QAM 256) and a second MCS (such as, 16 QAM) for the second spatial stream. One value of a field in the FLA element (such as, two or three bits) may indicate that a spatial stream corresponds to an equal QAM.

In some examples where UEQM is enabled, such as an open-loop (OL) transmission deployment, spatial streams may not be ordered, and any spatial stream may correspond to the highest SINR. In such examples, the FLA feedback information may include an index of the stream having the highest SINR. In some examples, the FLA feedback information also may include an MCS of the best spatial stream, and the SINR details to the other streams. In some examples, the FLA feedback information may include an MCS of the best spatial stream and one or more bits per stream indicating a modulation gap to the strongest stream for each stream (in the downward direction).

In some examples, FLA feedback may be supported in the case where an entire PSDU fails. For example, an indication (such as, at least one bit) may be included in a PHY preamble to request immediate response even when all MPDUs fail (such as, a negative acknowledgement (NACK)). The feedback indication may be included in a U-SIG field (such as U-SIG 266), or a UHR-SIG common field, and may include two bits. Each code point of the indicator may correspond to an expected response frame (such as SIFS after PPDU). For instance, for a first codepoint (such as 00), no immediate response may be expected. For a second code point (such as 01), an immediate response may be expected (such as a NACK if the PSDU fails, an ACK or BA as instructed by at least one successful MPDU, among other examples), but no FLA feedback may be expected. For a third code point (such as 10), an immediate response may be expected, and FLA feedback may be expected. In some examples, another code point (such as 11) may be reserved. For an MU PPDU, in some examples, a per-user SIG field may indicate such relevant information. Feedback indications and corresponding expected response frames are illustrated with reference to Table 1:

TABLE 1

| Feedback Indication | |
|---|---|
| in U-SIG or | |
| UHR-SIG common | Expected response frame (SIFS after |
| (2 bits ) | PPDU) |
| 00 | No immediate response is expected |
| 01 | Immediate response only (NACK if |
| | PSDU fail, AC/BA as instructed by at |
| | least one of the successful MPDUs). No |
| | fast link adaptation feedback is expected. |
| 10 | Immediate response (same as above) plus |
| | fast link adaptation feedback is expected |
| 11 | Reserved |

As described herein, techniques supporting FLA (such as, as a feature in UHR communications) may support open loop or closed loop cases. For example, in an open loop case, FLA request and FLA response message may be exchanged without explicit sounding. A packet sequence may support fast convergence to a good (such as, sufficient or efficient) MCS. For instance, a first packet in a packet sequence may be smaller (such as, corresponding to a conservative MCS) to retrieve FLA feedback. For instance, a first message may be sent by a transmitting deice, which may include data and an FLA request. The receiving device may transmit a message including a BA and an FLA element (such as, the first type of FLA element described herein). The message may include an enhanced MBA (eMBA) with FLA information. The transmitting device may then transmit data and a second FLA request, and the receiver may transmit a responsive message including another BA and another FLA element (such as another FLA element of the first type).

Techniques described herein may also support a closed loop case, in which case a sequence of messages may include explicit sounding. In such examples, an initial beamforming report may carry FLA feedback (such as FLA information such as FLA-optimal feedback for an optimal configuration). Such techniques may enable faster convergence, as an initial data transmission may have a high level of MCS accuracy. In such examples, a first message sent by the transmitter may include an NDPA and an FLA request. The transmitter may also transmit an NDP and a BFRP. The receiver may transmit a message including a BFR and an FLA element (such as, an eBFR with FLA feedback). The FLA element may be an FLA element of the second type described herein. The FLA element may suggest a rank, MCS, QAM pattern, and the like. In such examples, such a message may be referred to as an enhanced CQI report (such as, a CQI report indicating additional parameters such as rank, MCS, QAM pattern, for the additional streams). The transmitter may transmit beamformed data and a second FLA request. The beamformed data and FLA request may be transmitted at a highly accurate MCS (for instance, as a result of the BFR and FLA element). The receiver may respond with another message including a BA and another FLA element (such as, an FLA element of the second type). Use of techniques described herein may support consistent and accurate MCS feedback procedures, resulting in improved throughput, increased reliability, and performance improvements.

IN some examples, feedback of MCS may be more efficient or beneficial than soft effective SINR metrics. A receiver device may be aware of a precise receiver being used for signaling, and may have access to best (such as, most accurate, most up to date, most complete) information about an exact MCS which can be supported for current channel conditions. MCS feedback in FLA may avoid a tedious process at the AP to keep track of multiple SNR-to-rate mapping tables (such as, one table for every associated STA). To improve the effectiveness of MCS feedback, an MCS feedback procedure (such as, the techniques described herein) are consistent and ensure accuracy (because without stringent enforcement, any FLA feedback designs may not lead to actual performance benefits). Some techniques may be applied to predict MCS across a wide variety of channel conditions (such as SINR physical layer abstraction), however, techniques described herein support MCS feedback based on accurate and current information regarding current channel conditions experienced by a given STA.

FIG. 6 shows an example of a PPDU 600 that supports communications for fast link adaptation. The PPDU 600 may implement aspects of, or be implemented by aspects of, the pictorial diagram of the example wireless communication network 100, the example PPDU 250, the PPDU 300, and the example wireless communication network 400, and the timeline 500. For example, the PPDU 600 may be an example of the PPDU 250, the PPDU 300, or the PPDU 510, as described with reference to FIGS. 2-5.

In some examples, as described in greater detail with reference to FIG. 5, a transmitter may transmit a PPDU 600, which may include FLA request information. The PPDU 600 may include a preamble 602 (which may be an example of the preamble 302), an RL-SIG 604 (which may be an example of the L-SIG 264), an U-SIG 606 (which may be an example of the U-SIG 266), a UHR-SIG 608 (which may be an example of or similar to the EHT-SIG 268), an STF field (such as the UHR-STF 610), and one or more LTF fields (such as the UHR-LTFs 612), and a data field 614 (which may be an example of a data field 274).

In some examples, the PPDU 600 may include an indication of a quantity of spatial streams (such as, the quantity of spatial streams used to transmit the PPDU 600). The quantity of spatial streams may be the same as or less than a quantity of UHR-LTFs 612. The indication of the quantity of spatial streams may be referred to as the number of spatial streams (Nss). An Nss field and a quantity of LTF (N_LTF) field may be separate fields. For instance, a first Nss row of an N-LTF P matrix may be used to modulate the LTF section of the PPDU 600. However, in some examples, the transmitter may enable estimation of a greater quantity of spatial streams than the quantity of streams indicated by the Nss (such as, when the PPDU 600 requests the second type of FLA element, as described in greater detail with reference to FIG. 2). In such examples, the PPDU 600 may be used to indicate a quantity of extra streams to measure or report in the FLA feedback information.

The PPDU 600 may include an indication of the first quantity of spatial streams used for transmitting the PPDU 600, and an indication of a number of extra streams (Nes). In some examples, the Nss value and the Nes value may be included in the UHR-SIG 608. The Nes may indicate a total quantity of streams active in the LTF sections of the PPDU 600 (such as, the UHR-LTFs 612), as defined by Nss+Nes. In such examples, a matrix for mapping spatial streams (which may be referred to as a P matrix) may use Nss+Nes rows of the P-matrix. FLA calculations may account for up to Nss+Nes streams. The indication of Nes may include a small quantity of bits (such as one to three bits).

The UHR-LTFs may include more LTFs than is needed for data decoding. That is, for the first type of FLA information (such as, for a quantity of spatial layers used to transmit the PPDU 600), the PPDU 600 may include a quantity of UHR-LTFs that is at least equal to the quantity of spatial layers used for transmission of the PPDU 600. However, for the second type of FLE information, the UHR-LTFs 612 may include more LTFs than the number of spatial layers used for transmission of the PPDU 600. The Nes may indicate an extra quantity of spatial layers to be measured by the receiver, and the quantity of LTFs may be at least Nss+Nes.

FIG. 7 shows an example of an eMBA 700 that supports communications for fast link adaptation. The eMBA 700 may implement aspects of, or be implemented by aspects of, the pictorial diagram of the example wireless communication network 100, the example wireless communication network 400, and the timeline 500. In some examples, the eMBA may be an example of a message carrying FLA feedback information. Such FLA feedback information may be transmitted by a receiver in response to an FLA request message, which may be carried by a PPDU, such as the PPDU 250, the PPDU 300, the PPDU 510, or the PPDU 600, as described with reference to FIGS. 2-6.

The eMBA 700 may include one or more fields, such as a frame control field 702, a duration field 704, a receiver address (RA) field 706, a transmitter address (TA) field 708, a BA control field 710, a BA information field 712, and an FCS field 714. The BA information field 712 may include one or more AID TID information fields (such as the AID TID Information 716-a and the AID TID Information field 716-b), one or more BA starting sequence control fields 718 (the BA starting sequence control field 718-a and the BA starting sequence control field 718-b), the BA bitmap 720, and the control feedback 722.

The control feedback 722 may include the FLA feedback information described herein. For example, an Ack type subfield value (such as 0) and a TID subfield value (such as 13), and an indication in the BA starting sequence control field 718-b (such as present) may indicate the presence of control feedback in the control feedback 722. The control feedback 722 may be sent in response to a message, such as a PPDU or PSDU, and may contain control feedback for the addressed STA. The control feedback may include the FLA elements described herein in greater detail with reference to FIG. 5.

FIG. 8 shows an example of a timeline 800 that supports communications for FLA. The timeline 800 may implement aspects of, or may be implemented by aspects of, FIGS. 1-7. For example, a transmitting device (such as the AP 802) and a receiving device (such as the STA 804) may be examples of corresponding devices described with reference to FIGS. 1-7, and may communicate according to the timeline 800.

In some examples, a BFR 816 may carry FLA feedback (such as one or more FLA elements). For example, the AP 802 and the STA 804 may communicate using CRTSs 806 and eCTSs 808. The eRTSs 806 and the eCTSs 808 may be used for non-FLA operations. The AP 802 may transmit an NDPA 810, and an NDP 812. The AP 802 may transmit one or more BFRPs 814. In some examples, the FLA request message (such as the FLA request described with reference to FIG. 5) may be included in the NDPA 810, the NDP 812, the BFRP 814, or any combination thereof. The FLA feedback information (the one or more FLA elements described with reference to FIGS. 5-7) may be included in one or more BFRs 816. The BFRs 816 may be modified BFRs, with fields to carry the FLA elements. Based on the FLA elements, the PPDU 818 may be transmitted based on the FLA information reported in the BFRs 816. In some examples, the PPDU 818 may be an HE PDU, an EHT PPDU, or a UHR PPDU, among other examples. The PPDU 818 may include another FLA request, and the eMBAs 820 may include additional FLA elements in response.

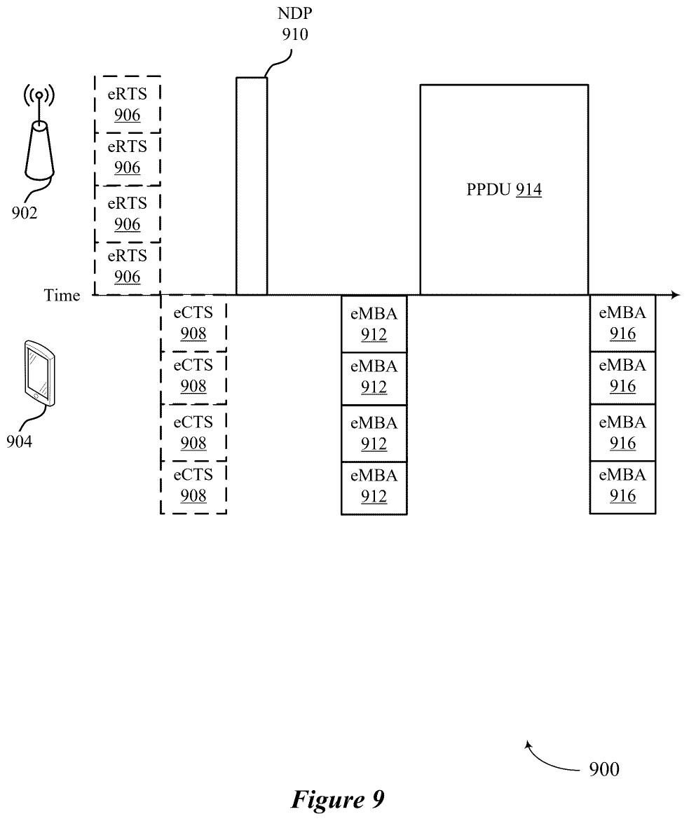

FIG. 9 shows an example of a timeline 900 that supports communications for FLA. The timeline 900 may implement aspects of, or may be implemented by aspects of, FIGS. 1-8. For example, a transmitting device (such as the AP 902) and a receiving device (such as the STA 904) may be examples of corresponding devices described with reference to FIGS. 1-8, and may communicate according to the timeline 900.

In some examples, FLA information may be reported via the eMBAs 912, and may be requested via an NDP 910. For example, the AP 902 may transmit one or more eRTSs 906, which may perform the tasks and operations of an NDPA. The STA 904 may transmit eCTSs 908 in response to the eRTSs 906. The AP 902 may perform CQI and transmit an NDP 910. The NDP 910 may carry the FLA request message (such as the FLA request message described with reference to FIGS. 5-8). The STA 904 may transmit one or more eMBAs 912, which may carry the FLA feedback information (such as one or more FLA elements described with reference to FIGS. 5-8).

Based on the FLA elements included in the eMBAs 912, the PPDU 914 may be transmitted. In some examples, the PPDU 914 may be an HE PDU, an EHT PPDU, or a UHR PPDU, among other examples. The PPDU 914 may include another FLA request, and the eMBAs 916 may include additional FLA elements in response.

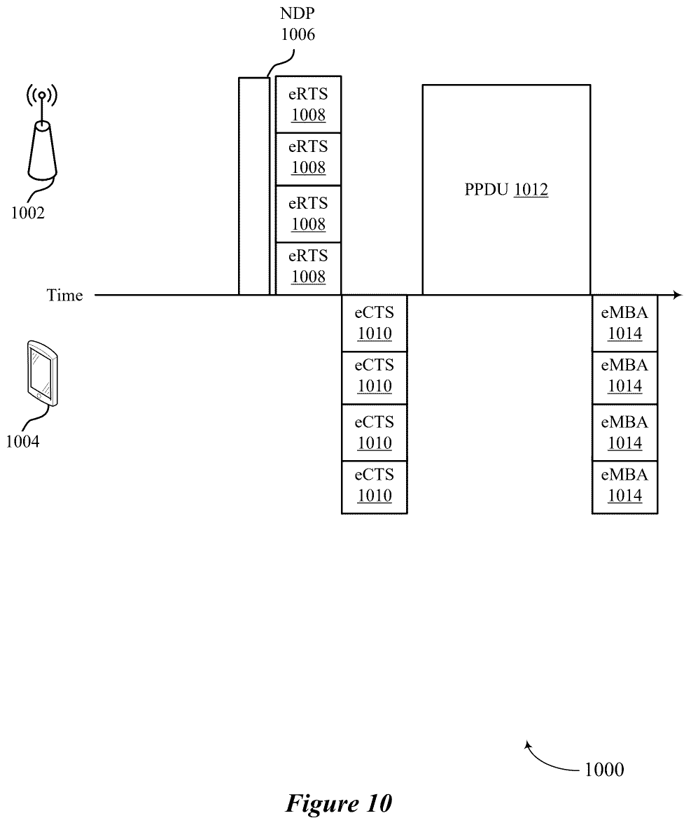

FIG. 10 shows an example of a timeline 1000 that supports communications for FLA. The timeline 1000 may implement aspects of, or may be implemented by aspects of, FIGS. 1-9. For example, a transmitting device (such as the AP 1002) and a receiving device (such as the STA 1004) may be examples of corresponding devices described with reference to FIGS. 1-9, and may communicate according to the timeline 1000.

In some examples, the FLA feedback information may be transmitted via an eCTS 1010. For example, the AP 1002 may perform CQI measurements across a whole BW, transmit an NDP 1006, and may transmit one or more eRTSs 1008. The eRTSs 1008 may include an FLA information request, such as the FLA request messages described with reference to FIGS. 5-9. The STA 1004 may transmit the eCTSs 1010, which may include one or more FLA elements, such as the FLA elements described with reference to FIGS. 5-9. The AP 1002 may transmit the PPDU 1012 according to parameter values indicated in the FLA feedback information received via the eCTSs 1010. The PPDU 1012 may be an HE PPDU, an EHT PPDU, or a UHR PPDU, among other examples. The STA 1004 may transmit the eMBAs 1014, which may indicate additional FLA elements if the PPDU 1012 includes another FLA request.

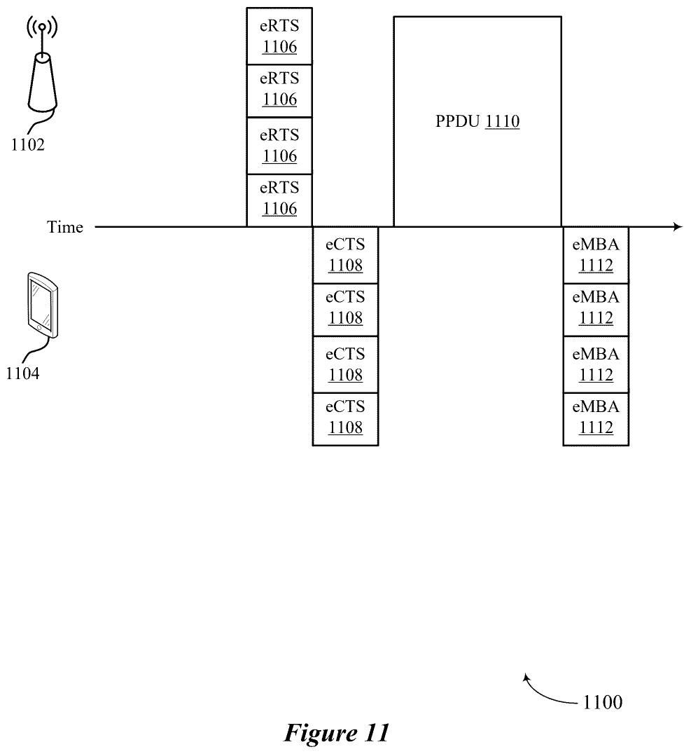

FIG. 11 shows an example of a timeline 1100 that supports communications for FLA. The timeline 1100 may implement aspects of, or may be implemented by aspects of, FIGS. 1-10. For example, a transmitting device (such as the AP 1102) and a receiving device (such as the STA 1104) may be examples of corresponding devices described with reference to FIGS. 1-10, and may communicate according to the timeline 1100.

In some examples, eCTSs 1108 may carry FLA feedback information. In such examples, the AP 1102 may transmit eRTSs 1106, which may include an FLA request message, such as the FLA requests described with reference to FIGS. 5-10. The AP 1102 may perform coarse CQI measurements per channel (such as, per 20 MHz channel), and may transmit the eRTSs 1106. The STA 1104 may transmit the eCTSs 1108, and may include the FLA elements in the eCTSs 1108. The AP 1102 may transmit the PPDU 1110 according to parameter values indicated in the FLA feedback information received via the eCTSs 1108. The PPDU 1110 may be an HE PPDU, an EHT PPDU, or a UHR PPDU, among other examples. The STA 1104 may transmit the eMBAs 1112, which may indicate additional FLA elements if the PPDU 1110 includes another FLA request.

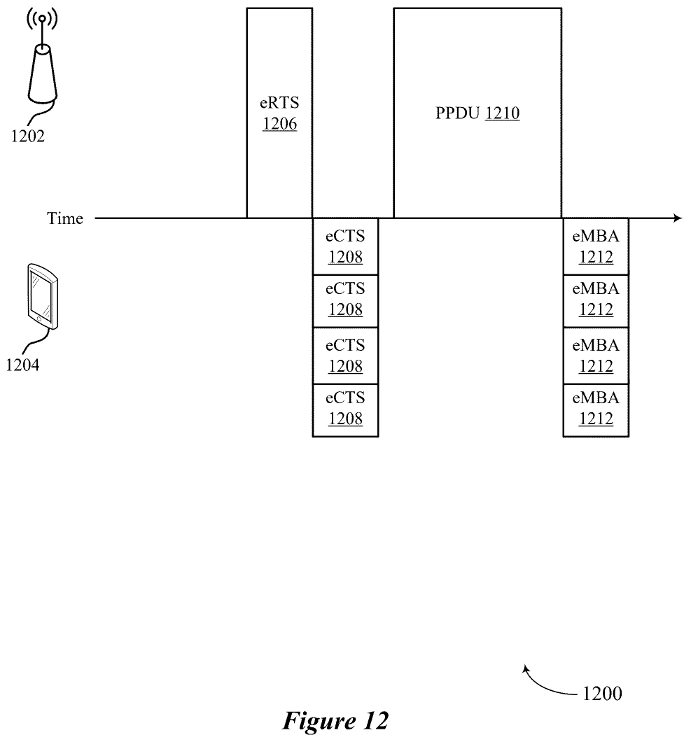

FIG. 12 shows an example of a timeline 1200 that supports communications for FLA. The timeline 1200 may implement aspects of, or may be implemented by aspects of, FIGS. 1-11. For example, a transmitting device (such as the AP 1202) and a receiving device (such as the STA 1204) may be examples of corresponding devices described with reference to FIGS. 1-11, and may communicate according to the timeline 1200.

In some examples, eCTSs 1208 may carry FLA feedback information. In such examples, the AP 1202 may transmit an eRTS 1206, which may include an FLA request message, such as the FLA requests described with reference to FIGS. 5-10. The AP 1102 may perform CQI measurements across an available bandwidth, and may transmit the eRTS 1206. The STA 1204 may transmit the eCTS 1208, and may include the FLA elements in the eCTSs 1108. The AP 1102 may transmit the PPDU 1210 according to parameter values indicated in the FLA feedback information received via the eCTSs 1208. The PPDU 1210 may be an HE PPDU, an EHT PPDU, or a UHR PPDU, among other examples. The STA 1204 may transmit the eMBAs 1212, which may indicate additional FLA elements if the PPDU 1110 includes another FLA request.

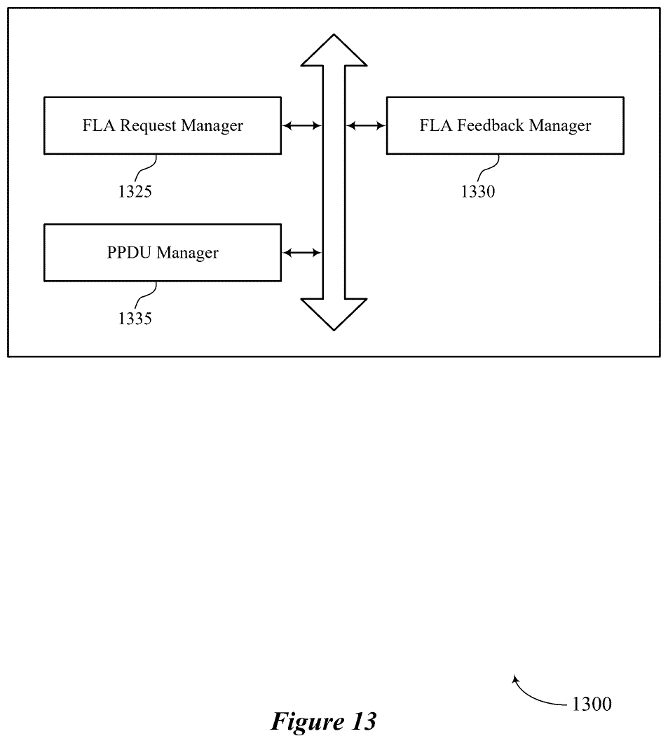

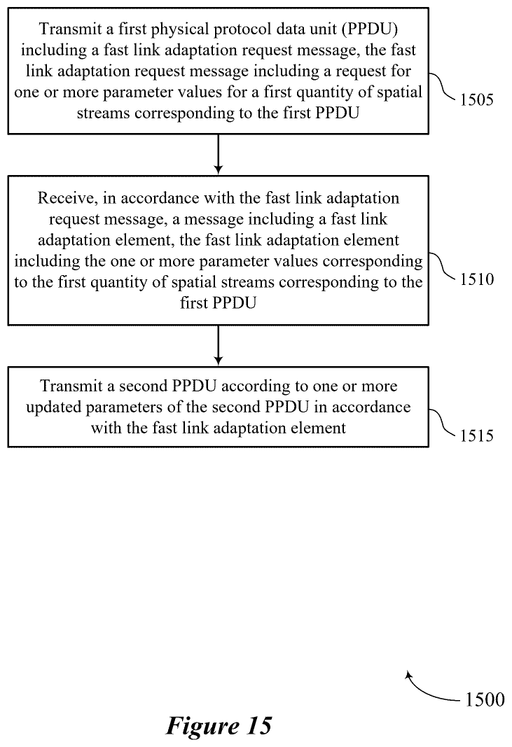

FIG. 13 shows a block diagram of an example wireless communication device 1300 that supports communications for FLA. In some examples, the wireless communication device 1300 is configured to perform the process 1500 described with reference to FIG. 15. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 may be an example of a wireless device. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a FLA request manager 1325, a FLA feedback manager 1330, and a PPDU manager 1335. Portions of one or more of the FLA request manager 1325, the FLA feedback manager 1330, and the PPDU manager 1335 may be implemented at least in part in hardware or firmware. For example, one or more of the FLA request manager 1325, the FLA feedback manager 1330, and the PPDU manager 1335 may be implemented at least in part by at least a processor or a modem. In some examples, portions of one or more of the FLA request manager 1325, the FLA feedback manager 1330, and the PPDU manager 1335 may be implemented at least in part by a processor and software in the form of processor-executable code stored in memory.

The wireless communication device 1300 may support wireless communications in accordance with examples as disclosed herein. The FLA request manager 1325 is configurable or configured to transmit a first PPDU including a FLA request message, the FLA request message including a request for one or more parameter values for a first quantity of spatial streams corresponding to the first PPDU. The FLA feedback manager 1330 is configurable or configured to receive, in accordance with the FLA request message, an MBA message, a FLA element in the MBA message including the one or more parameter values corresponding to the first quantity of spatial streams corresponding to the first PPDU. The PPDU manager 1335 is configurable or configured to transmit a second PPDU according to one or more updated parameters of the second PPDU in accordance with the FLA element.

In some examples, the FLA request message includes an indication that a STA is to report a second FLA element corresponding to a second quantity of spatial streams that is different than the first quantity of spatial streams.

In some examples, the first PPDU includes a numerical quantity of long training fields that is greater than or equal to the second quantity of spatial streams.

In some examples, the first PPDU includes a first indication of the first quantity of spatial streams, and a second indication of a quantity of additional spatial streams, a sum of the first quantity of spatial streams and the quantity of additional spatial streams being greater than or equal to the second quantity of spatial streams.

In some examples, the one or more parameter values in the FLA element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

In some examples, a second FLA element includes an indication of a proposed second quantity of spatial streams different than the first quantity of spatial streams, a third modulation and coding scheme corresponding to the proposed second quantity of spatial streams, a third signal to noise ratio margin corresponding to the third modulation and coding scheme, a fourth signal to noise ratio margin corresponding to a fourth modulation and coding scheme, a second indication to drop one or more of the first quantity of spatial streams, or any combination thereof.

In some examples, unequal modulation is enabled and the one or more parameter values includes an indication of a first modulation and coding scheme corresponding to a first spatial stream of the first quantity of spatial streams.

In some examples, the FLA element includes a set of multiple offsets from a first SINR corresponding to the first modulation and coding scheme, each offset of the set of multiple offsets corresponding to a respective spatial stream of a remainder of the first quantity of spatial streams.

In some examples, the FLA element includes a set of multiple offsets from the first modulation and coding scheme, each offset of the set of multiple offsets corresponding to a respective spatial stream of a remainder of the first quantity of spatial streams.

In some examples, the first quantity of spatial streams are indicated in a descending order of SINR, the first spatial stream of the first quantity of spatial streams having a lowest SINR. In some examples, the indication of the first modulation and coding scheme corresponding to the first spatial stream of the first quantity of spatial streams is in accordance with the first spatial stream having the lowest SINR.

In some examples, unequal modulation is enabled and the one or more parameter values includes an indication of a first SINR corresponding to a first spatial stream of the first quantity of spatial streams.

In some examples, the FLA element includes a first modulation and coding scheme corresponding to the first spatial stream, and a set of multiple offsets from the first SINR, each offset of the set of multiple offsets corresponding to a respective spatial stream of a remainder of the first quantity of spatial streams.

In some examples, the FLA element includes a first modulation and coding scheme corresponding to the first spatial stream, and a set of multiple modulation gaps from the first modulation and coding scheme, each modulation gap of the set of multiple modulation gaps corresponding to a respective spatial stream of a remainder of the first quantity of spatial streams.

In some examples, the PPDU is transmitted via a numerical quantity of spatial streams that is greater than or equal to the first quantity of spatial streams, each spatial stream of the numerical quantity of spatial streams corresponding to a respective modulation and coding scheme of a set of multiple modulation and coding schemes.

In some examples, the one or more parameter values for the first quantity of spatial streams corresponding to the first PPDU includes one or more proposed updates to be applied to a current set of parameter values corresponding to the first quantity of spatial streams and the first PPDU.

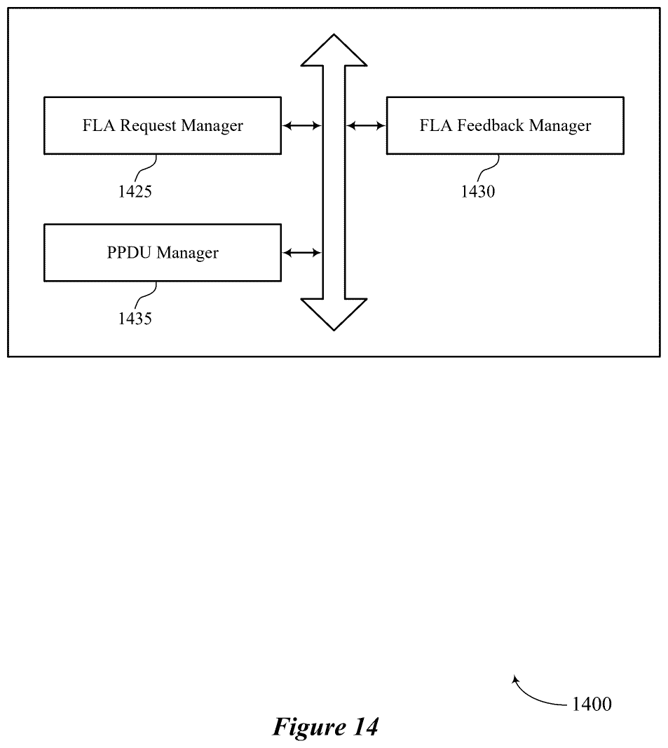

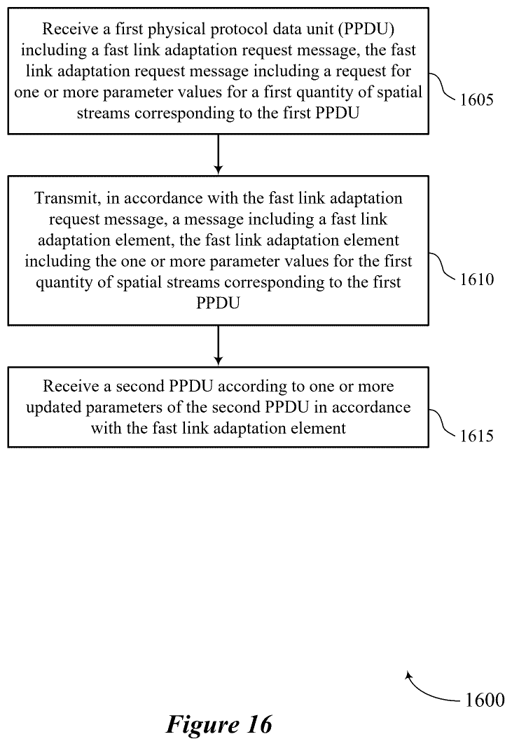

FIG. 14 shows a block diagram of an example wireless communication device 1400 that supports communications for FLA. In some examples, the wireless communication device 1400 is configured to perform the process 1600 described with reference to FIG. 16. The wireless communication device 1400 may include one or more chips, SoCs, chipsets, packages, components or devices that individually or collectively constitute or include a processing system. The processing system may interface with other components of the wireless communication device 1400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1400 may transmit the information output from the chip. In such an example, the second interface may refer to an interface between the processing system of the chip and a reception component, such that the wireless communication device 1400 may receive information that is then passed to the processing system. In some such examples, the first interface also may obtain information, such as from the transmission component, and the second interface also may output information, such as to the reception component.

The processing system of the wireless communication device 1400 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

In some examples, the wireless communication device 1400 can be configurable or configured for use in a STA, such as the STA 104 described with reference to FIG. 1. In some other examples, the wireless communication device 1400 can be a STA that includes such a processing system and other components including multiple antennas. The wireless communication device 1400 may be an example of a wireless device. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some examples, the wireless communication device 1400 also includes or can be coupled with one or more application processors which may be further coupled with one or more other memories. In some examples, the wireless communication device 1400 further includes a user interface (UI) (such as a touchscreen or keypad) and a display, which may be integrated with the UI to form a touchscreen display that is coupled with the processing system. In some examples, the wireless communication device 1400 may further include one or more sensors such as, for example, one or more inertial sensors, accelerometers, temperature sensors, pressure sensors, or altitude sensors, that are coupled with the processing system.

The wireless communication device 1400 includes a FLA request manager 1425, a FLA feedback manager 1430, and a PPDU manager 1435. Portions of one or more of the FLA request manager 1425, the FLA feedback manager 1430, and the PPDU manager 1435 may be implemented at least in part in hardware or firmware. For example, one or more of the FLA request manager 1425, the FLA feedback manager 1430, and the PPDU manager 1435 may be implemented at least in part by at least a processor or a modem. In some examples, portions of one or more of the FLA request manager 1425, the FLA feedback manager 1430, and the PPDU manager 1435 may be implemented at least in part by a processor and software in the form of processor-executable code stored in memory.

The wireless communication device 1400 may support wireless communications in accordance with examples as disclosed herein. The FLA request manager 1425 is configurable or configured to receive a first PPDU including a FLA request message, the FLA request message including a request for one or more parameter values for a first quantity of spatial streams corresponding to the first PPDU. The FLA feedback manager 1430 is configurable or configured to transmit, in accordance with the FLA request message, an MBA message, a FLA element in the MBA message including the one or more parameter values for the first quantity of spatial streams corresponding to the first PPDU. The PPDU manager 1435 is configurable or configured to receive a second PPDU according to one or more updated parameters of the second PPDU in accordance with the FLA element.

In some examples, the FLA request message includes an indication that the STA is to report a second FLA element corresponding to a second quantity of spatial streams that is different than the first quantity of spatial streams.

In some examples, the first PPDU includes a numerical quantity of long training fields that is greater than or equal to the second quantity of spatial streams.

In some examples, the first PPDU includes a first indication of the first quantity of spatial streams, and a second indication of a quantity of additional spatial streams, a sum of the first quantity of spatial streams and the quantity of additional spatial streams being greater than or equal to the second quantity of spatial streams.

In some examples, the first PPDU includes an instruction to perform one or more measurements on at least one of the quantity of additional spatial streams.

In some examples, the FLA feedback manager 1430 is configurable or configured to perform a first set of measurements according to the request for one or more parameter values for the first quantity of spatial streams corresponding to the first PPDU. In some examples, the FLA feedback manager 1430 is configurable or configured to perform the one or more measurements according to the instruction based on the first quantity of spatial streams and the at least one of the quantity of additional spatial streams.

In some examples, the FLA feedback manager 1430 is configurable or configured to generate the FLA element corresponding to the first set of measurements and a second FLA element corresponding to the one or more measurements, the MBA message including the FLA element and the second FLA element.

In some examples, the one or more parameter values in the FLA element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

In some examples, a second FLA element includes an indication of a proposed second quantity of spatial streams different than the first quantity of spatial streams, a third modulation and coding scheme corresponding to the proposed second quantity of spatial streams, a third signal to noise ratio margin corresponding to the second modulation and coding scheme, a fourth signal to noise ratio margin corresponding to a fourth modulation and coding scheme, a second indication to drop one or more of the first quantity of spatial streams, or any combination thereof.

In some examples, unequal modulation is enabled and the one or more parameter values includes an indication of a first modulation and coding scheme corresponding to a first spatial stream of the first quantity of spatial streams.

In some examples, the FLA element includes a set of multiple offsets from a first SINR corresponding to the first modulation and coding scheme, each offset of the set of multiple offsets corresponding to a respective spatial stream of a remainder of the first quantity of spatial streams.

In some examples, the FLA element includes a set of multiple offsets from the first modulation and coding scheme, each offset of the set of multiple offsets corresponding to a respective spatial stream of a remainder of the first quantity of spatial streams.

In some examples, the first quantity of spatial streams is indicated in a descending order of SINR, the first spatial stream of the first quantity of spatial streams having a lowest SINR. In some examples, the indication of the first modulation and coding scheme corresponding to the first spatial stream of the first quantity of spatial streams is in accordance with the first spatial stream having the lowest SINR.

In some examples, unequal modulation is enabled and the one or more parameter values includes an indication of a first SINR corresponding to a first spatial stream of the first quantity of spatial streams.

In some examples, the FLA element includes a first modulation and coding scheme corresponding to the first spatial stream, and a set of multiple offsets from the first SINR, each offset of the set of multiple offsets corresponding to a respective spatial stream of a remainder of the first quantity of spatial streams.

In some examples, the FLA element includes a first modulation and coding scheme corresponding to the first spatial stream, and a set of multiple modulation gaps from the first modulation and coding scheme, each modulation gap of the set of multiple modulation gaps corresponding to a respective spatial stream of a remainder of the first quantity of spatial streams.

FIG. 15 shows a flowchart illustrating an example process 1500 performable by or at an AP that supports communications for FLA. The operations of the process 1500 may be implemented by an AP or its components as described herein. For example, the process 1500 may be performed by a wireless communication device, such as the wireless communication device 1300 described with reference to FIG. 13, operating as or within a wireless AP. In some examples, the process 1500 may be performed by a wireless AP, such as one of the APs 102 described with reference to FIG. 1.

In some examples, in block 1505, the AP may transmit a first PPDU including a FLA request message, the FLA request message including a request for one or more parameter values for a first quantity of spatial streams corresponding to the first PPDU. The operations of block 1505 may be performed in accordance with examples as disclosed herein. In some implementations, aspects of the operations of block 1505 may be performed by a FLA request manager 1325 as described with reference to FIG. 13.

In some examples, in block 1510, the AP may receive, in accordance with the FLA request message, an MBA message, a FLA element in the MBA message including the one or more parameter values corresponding to the first quantity of spatial streams corresponding to the first PPDU. The operations of block 1510 may be performed in accordance with examples as disclosed herein. In some implementations, aspects of the operations of block 1510 may be performed by a FLA feedback manager 1330 as described with reference to FIG. 13.

In some examples, in block 1515, the AP may transmit a second PPDU according to one or more updated parameters of the second PPDU in accordance with the FLA element. The operations of block 1515 may be performed in accordance with examples as disclosed herein. In some implementations, aspects of the operations of block 1515 may be performed by a PPDU manager 1335 as described with reference to FIG. 13.

FIG. 16 shows a flowchart illustrating an example process 1600 performable by or at a STA that supports communications for FLA. The operations of the process 1600 may be implemented by a STA or its components as described herein. For example, the process 1600 may be performed by a wireless communication device, such as the wireless communication device 1400 described with reference to FIG. 14, operating as or within a wireless STA. In some examples, the process 1600 may be performed by a wireless STA, such as one of the STAs 104 described with reference to FIG. 1.

In some examples, in block 1605, the STA may receive a first PPDU including a FLA request message, the FLA request message including a request for one or more parameter values for a first quantity of spatial streams corresponding to the first PPDU. The operations of block 1605 may be performed in accordance with examples as disclosed herein. In some implementations, aspects of the operations of block 1605 may be performed by a FLA request manager 1425 as described with reference to FIG. 14.

In some examples, in block 1610, the STA may transmit, in accordance with the FLA request message, an MBA message, a FLA element in the MBA message including the one or more parameter values for the first quantity of spatial streams corresponding to the first PPDU. The operations of block 1610 may be performed in accordance with examples as disclosed herein. In some implementations, aspects of the operations of block 1610 may be performed by a FLA feedback manager 1430 as described with reference to FIG. 14.

In some examples, in block 1615, the STA may receive a second PPDU according to one or more updated parameters of the second PPDU in accordance with the FLA element. The operations of block 1615 may be performed in accordance with examples as disclosed herein. In some implementations, aspects of the operations of block 1615 may be performed by a PPDU manager 1435 as described with reference to FIG. 14.

Implementation examples are described in the following numbered clauses:

Clause 1: A method for wireless communications at an AP, comprising: transmitting a first physical protocol data unit (PPDU) including a fast link adaptation request message, the fast link adaptation request message including a request for one or more parameter values for a first quantity of spatial streams corresponding to the first PPDU; receiving, in accordance with the fast link adaptation request message, a message including a fast link adaptation element, the fast link adaptation element including the one or more parameter values corresponding to the first quantity of spatial streams corresponding to the first PPDU; and transmitting a second PPDU according to one or more updated parameters of the second PPDU in accordance with the fast link adaptation element.

Clause 2: The method of clause 1, wherein the fast link adaptation request message includes an indication that a STA is to report a second fast link adaptation element corresponding to a second quantity of spatial streams that is different than the first quantity of spatial streams.

Clause 3: The method of clause 2, wherein the first PPDU includes a numerical quantity of long training fields that is greater than or equal to the second quantity of spatial streams.

Clause 4: The method of any of clauses 2 through 3, wherein the first PPDU includes a first indication of the first quantity of spatial streams, and a second indication of a quantity of additional spatial streams, a sum of the first quantity of spatial streams and the quantity of additional spatial streams being greater than or equal to the second quantity of spatial streams.

Clause 5: The method of any of clauses 1 through 4, wherein the one or more parameter values in the fast link adaptation element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

Clause 6: The method of clause 5, wherein a second fast link adaptation element includes an indication of a proposed second quantity of spatial streams different than the first quantity of spatial streams, a third modulation and coding scheme corresponding to the proposed second quantity of spatial streams, a third signal to noise ratio margin corresponding to the third modulation and coding scheme, a fourth signal to noise ratio margin corresponding to a fourth modulation and coding scheme, a second indication to drop one or more of the first quantity of spatial streams, or any combination thereof.

Clause 7: The method of any of clauses 1 through 6, wherein unequal modulation is enabled and the one or more parameter values includes an indication of a first modulation and coding scheme corresponding to a first spatial stream of the first quantity of spatial streams.

Clause 8: The method of clause 7, wherein the fast link adaptation element includes a plurality of offsets from a first signal to interference and noise ratio (SINR) corresponding to the first modulation and coding scheme, each offset of the plurality of offsets corresponding to a respective spatial stream of a remainder of the first quantity of spatial streams.

Clause 9: The method of any of clauses 7 through 8, wherein the fast link adaptation element includes a plurality of offsets from the first modulation and coding scheme, each offset of the plurality of offsets corresponding to a respective spatial stream of a remainder of the first quantity of spatial streams.

Clause 10: The method of any of clauses 7 through 9, wherein the first quantity of spatial streams are indicated in a descending order of signal to interference and noise ratio (SINR), the first spatial stream of the first quantity of spatial streams having a lowest SINR, the indication of the first modulation and coding scheme corresponding to the first spatial stream of the first quantity of spatial streams is in accordance with the first spatial stream having the lowest SINR.

Clause 11: The method of any of clauses 1 through 10, wherein unequal modulation is enabled and the one or more parameter values includes an indication of a first signal to interference and noise ratio (SINR) corresponding to a first spatial stream of the first quantity of spatial streams.

Clause 12: The method of clause 11, wherein the fast link adaptation element includes a first modulation and coding scheme corresponding to the first spatial stream, and a plurality of offsets from the first SINR, each offset of the plurality of offsets corresponding to a respective spatial stream of a remainder of the first quantity of spatial streams.

Clause 13: The method of any of clauses 11 through 12, wherein the fast link adaptation element includes a first modulation and coding scheme corresponding to the first spatial stream, and a plurality of modulation gaps from the first modulation and coding scheme, each modulation gap of the plurality of modulation gaps corresponding to a respective spatial stream of a remainder of the first quantity of spatial streams.

Clause 14: The method of any of clauses 11 through 13, wherein the PPDU is transmitted via a numerical quantity of spatial streams that is greater than or equal to the first quantity of spatial streams, each spatial stream of the numerical quantity of spatial streams corresponding to a respective modulation and coding scheme of a plurality of modulation and coding schemes.

Clause 15: The method of any of clauses 1 through 14, wherein the one or more parameter values for the first quantity of spatial streams corresponding to the first PPDU includes one or more proposed updates to be applied to a current set of parameter values corresponding to the first quantity of spatial streams and the first PPDU.

Clause 16: A method for wireless communications at a wireless device, comprising: receiving a first physical protocol data unit (PPDU) including a fast link adaptation request message, the fast link adaptation request message including a request for one or more parameter values for a first quantity of spatial streams corresponding to the first PPDU; transmitting, in accordance with the fast link adaptation request message, a message including a fast link adaptation element, the fast link adaptation element including the one or more parameter values for the first quantity of spatial streams corresponding to the first PPDU; and receiving a second PPDU according to one or more updated parameters of the second PPDU in accordance with the fast link adaptation element.

Clause 17: The method of clause 16, wherein the fast link adaptation request message includes an indication that the wireless device is to report a second fast link adaptation element corresponding to a second quantity of spatial streams that is different than the first quantity of spatial streams.

Clause 18: The method of clause 17, wherein the first PPDU includes a numerical quantity of long training fields that is greater than or equal to the second quantity of spatial streams.

Clause 19: The method of any of clauses 17 through 18, wherein the first PPDU includes a first indication of the first quantity of spatial streams, and a second indication of a quantity of additional spatial streams, a sum of the first quantity of spatial streams and the quantity of additional spatial streams being greater than or equal to the second quantity of spatial streams.

Clause 20: The method of clause 19, wherein the first PPDU includes an instruction to perform one or more measurements on at least one of the quantity of additional spatial streams.

Clause 21: The method of clause 20, further comprising: performing a first set of measurements according to the request for one or more parameter values for the first quantity of spatial streams corresponding to the first PPDU; and performing the one or more measurements according to the instruction based on the first quantity of spatial streams and the at least one of the quantity of additional spatial streams.

Clause 22: The method of clause 21, further comprising: generating the fast link adaptation element corresponding to the first set of measurements and a second fast link adaptation element corresponding to the one or more measurements, the MBA message including the fast link adaptation element and the second fast link adaptation element.

Clause 23: The method of any of clauses 16 through 22, wherein the one or more parameter values in the fast link adaptation element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

Clause 24: The method of clause 23, wherein a second fast link adaptation element includes an indication of a proposed second quantity of spatial streams different than the first quantity of spatial streams, a third modulation and coding scheme corresponding to the proposed second quantity of spatial streams, a third signal to noise ratio margin corresponding to the second modulation and coding scheme, a fourth signal to noise ratio margin corresponding to a fourth modulation and coding scheme, a second indication to drop one or more of the first quantity of spatial streams, or any combination thereof.

Clause 25: The method of any of clauses 16 through 24, wherein unequal modulation is enabled and the one or more parameter values includes an indication of a first modulation and coding scheme corresponding to a first spatial stream of the first quantity of spatial streams.

Clause 26: The method of clause 25, wherein the fast link adaptation element includes a plurality of offsets from a first signal to interference and noise (SINR) corresponding to the first modulation and coding scheme, each offset of the plurality of offsets corresponding to a respective spatial stream of a remainder of the first quantity of spatial streams.

Clause 27: The method of any of clauses 25 through 26, wherein the fast link adaptation element includes a plurality of offsets from the first modulation and coding scheme, each offset of the plurality of offsets corresponding to a respective spatial stream of a remainder of the first quantity of spatial streams.

Clause 28: The method of any of clauses 25 through 27, wherein the first quantity of spatial streams is indicated in a descending order of signal to interference and noise ratio (SINR), the first spatial stream of the first quantity of spatial streams having a lowest SINR, the indication of the first modulation and coding scheme corresponding to the first spatial stream of the first quantity of spatial streams is in accordance with the first spatial stream having the lowest SINR.

Clause 29: The method of any of clauses 16 through 28, wherein unequal modulation is enabled and the one or more parameter values includes an indication of a first signal to interference and noise ratio (SINR) corresponding to a first spatial stream of the first quantity of spatial streams.

Clause 30: The method of clause 29, wherein the fast link adaptation element includes a first modulation and coding scheme corresponding to the first spatial stream, and a plurality of offsets from the first SINR, each offset of the plurality of offsets corresponding to a respective spatial stream of a remainder of the first quantity of spatial streams.

Clause 31: The method of any of clauses 29 through 30, wherein the fast link adaptation element includes a first modulation and coding scheme corresponding to the first spatial stream, and a plurality of modulation gaps from the first modulation and coding scheme, each modulation gap of the plurality of modulation gaps corresponding to a respective spatial stream of a remainder of the first quantity of spatial streams.

Clause 32: An AP for wireless communications, comprising one or more memories storing processor-executable code, and one or more processors coupled with the one or more memories and individually or collectively operable to execute the code to cause the AP to perform a method of any of aspects 1 through 15.

Clause 33: An AP for wireless communications, comprising at least one means for performing a method of any of clauses 1 through 15.

Clause 34: A non-transitory computer-readable medium storing code for wireless communications, the code comprising instructions executable by one or more processors to perform a method of any of clauses 1 through 15.

Clause 35: An AP, comprising a processing system that includes processor circuitry and memory circuitry that stores code, the processing system configured to cause the AP to perform a method of any of clauses 1 through 15.

Clause 36: A wireless device for wireless communications, comprising one or more memories storing processor-executable code, and one or more processors coupled with the one or more memories and individually or collectively operable to execute the code to cause the STA to perform a method of any of clauses 16 through 31.

Clause 37: A wireless device for wireless communications, comprising at least one means for performing a method of any of clauses 16 through 31.

Clause 38: A non-transitory computer-readable medium storing code for wireless communications, the code comprising instructions executable by one or more processors to perform a method of any of clauses 16 through 31.

Clause 39: A wireless device, comprising a processing system that includes processor circuitry and memory circuitry that stores code, the processing system configured to perform a method of any of clauses 16 through 31.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
receive a first physical protocol data unit (PPDU) including a fast link adaptation request message, the fast link adaptation request message including a request for one or more parameter values for a first quantity of spatial streams corresponding to the first PPDU;
transmit, in accordance with the fast link adaptation request message, a message including a fast link adaptation element, the fast link adaptation element including the one or more parameter values for the first quantity of spatial streams corresponding to the first PPDU; and
receive a second PPDU according to one or more updated parameters of the second PPDU in accordance with the fast link adaptation element.

2. The wireless device of claim 1, wherein the fast link adaptation request message includes an indication that the wireless device is to report a second fast link adaptation element corresponding to a second quantity of spatial streams that is different than the first quantity of spatial streams.

3. The wireless device of claim 1, wherein the message including the fast link adaptation element is a block acknowledgement (BA) packet.

4. The wireless device of claim 1, wherein the first PPDU includes an instruction to perform one or more measurements on at least one of a quantity of additional spatial streams.

5. The wireless device of claim 4, wherein the message including the fast link adaptation element is a sounding feedback packet corresponding to a sounding phase.

6. The wireless device of claim 4, wherein the processing system is further configured to cause the wireless device to:
perform a first set of measurements according to the request for one or more parameter values for the first quantity of spatial streams corresponding to the first PPDU; and
perform the one or more measurements according to the instruction based on the first quantity of spatial streams and the at least one of the quantity of additional spatial streams.

7. The wireless device of claim 6, wherein the processing system is further configured to cause the wireless device to:
generate the fast link adaptation element corresponding to the first set of measurements and a second fast link adaptation element corresponding to the one or more measurements, the message including the fast link adaptation element and the second fast link adaptation element.

8. The wireless device of claim 1, wherein the one or more parameter values in the fast link adaptation element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

9. The wireless device of claim 8, wherein a second fast link adaptation element includes an indication of a proposed second quantity of spatial streams different than the first quantity of spatial streams, a third modulation and coding scheme corresponding to the proposed second quantity of spatial streams, a third signal to noise ratio margin corresponding to the second modulation and coding scheme, a fourth signal to noise ratio margin corresponding to a fourth modulation and coding scheme, a second indication to drop one or more of the first quantity of spatial streams, or any combination thereof.

10. The wireless device of claim 1, wherein the one or more parameter values in the fast link adaptation element include a first signal to interference and noise ratio margin indicting a first difference between a first calculated effective signal to interference and noise ratio and a first threshold effective signal to interference and noise ratio for a first spatial stream of the first quantity of spatial streams, and a second signal to interference and noise ratio margin indicting a second difference between a second calculated effective signal to interference and noise ratio and a second threshold effective signal to interference and noise ratio for a second spatial stream of the first quantity of spatial streams.

11. The wireless device of claim 1, wherein unequal modulation is enabled and the one or more parameter values includes an indication of a first modulation and coding scheme corresponding to a first spatial stream of the first quantity of spatial streams.

12. The wireless device of claim 11, wherein the fast link adaptation element includes a plurality of offsets from a first signal to interference and noise (SINR) corresponding to the first modulation and coding scheme, each offset of the plurality of offsets corresponding to a respective spatial stream of a remainder of the first quantity of spatial streams.

13. The wireless device of claim 11, wherein the fast link adaptation element includes a plurality of offsets from the first modulation and coding scheme, each offset of the plurality of offsets corresponding to a respective spatial stream of a remainder of the first quantity of spatial streams.

14. The wireless device of claim 11, wherein the first quantity of spatial streams is indicated in a descending order of signal to interference and noise ratio (SINR), the first spatial stream of the first quantity of spatial streams having a lowest SINR, the indication of the first modulation and coding scheme corresponding to the first spatial stream of the first quantity of spatial streams is in accordance with the first spatial stream having the lowest SINR.

15. The wireless device of claim 1, wherein unequal modulation is enabled and the one or more parameter values includes an indication of a first signal to interference and noise ratio (SINR) corresponding to a first spatial stream of the first quantity of spatial streams.

16. The wireless device of claim 1, wherein a preamble of the PPDU includes one or more bits comprising the fast link adaptation request message.

17. The wireless device of claim 16, further comprising:
detecting a failure of a physical layer convergence procedure (PLCP) service data unit (PSDU) corresponding to the PPDU, wherein transmitting the fast link adaptation element is based at least in part on receiving the fast link adaptation request message in the preamble of the PPDU.

18. A method for wireless communications at a wireless device, comprising:
receiving a first physical protocol data unit (PPDU) including a fast link adaptation request message, the fast link adaptation request message including a request for one or more parameter values for a first quantity of spatial streams corresponding to the first PPDU;
transmitting, in accordance with the fast link adaptation request message, a message including a fast link adaptation element, the fast link adaptation element including the one or more parameter values for the first quantity of spatial streams corresponding to the first PPDU; and
receiving a second PPDU according to one or more updated parameters of the second PPDU in accordance with the fast link adaptation element.

19. The method of claim 18, wherein the one or more parameter values in the fast link adaptation element include a modulation and coding scheme, the first quantity of spatial streams, a first signal to noise ratio margin corresponding to the modulation and coding scheme, a second signal to noise ratio margin corresponding to a second modulation and coding scheme, an indication to drop one or more of the first quantity of spatial streams, or any combination thereof.

20. A non-transitory computer-readable medium storing code for wireless communications, the code comprising instructions executable by one or more processors to:
transmit a first physical protocol data unit (PPDU) including a fast link adaptation request message, the fast link adaptation request message including a request for one or more parameter values for a first quantity of spatial streams corresponding to the first PPDU;
receive, in accordance with the fast link adaptation request message, a message including a fast link adaptation element, the fast link adaptation element including the one or more parameter values corresponding to the first quantity of spatial streams corresponding to the first PPDU; and
transmit a second PPDU according to one or more updated parameters of the second PPDU in accordance with the fast link adaptation element.
